(19) United States
(12) Patent Application Publication
(10) Pub. No.: US 2005/0034148 A1
(43) Pub. Date: Feb. 10, 2005

(54) System and method for recording and replaying property changes on graphic elements in a computer environment

(76) Inventor: Denny Jaeger, Oakland, CA (US)

Correspondence Address: Harris Zimmerman;Law Offices of Harris Zimmerman, Suite 710, 1330 Broadway, Oakland, CA, 94612-2506, US

(21) Appl. No.: 10/672,391

(22) Filed: Sep. 26, 2003

Related U.S. Application Data
(63) Continuation-in-part of application No. 10/635,756, filed on Aug. 5, 2003.

(51) Int. Cl. H04H 9/00; G06F 13/00; G06F 17/60; H04N 7/16; G06F 17/30

(52) U.S. Cl. 725/14; 725/46; 705/10; 707/104.1; 707/202; 707/204

(57) ABSTRACT

A system and method for recording and replaying property changes on graphic elements in a computer environment provides a user with the ability to record his/her interactions with controls in the computer environment and then to replay these interactions. Both graphical and functional information are recorded for all objects in the computer environment such that, during replay, the recorded graphic elements are actually being interacted with in the same manner as during the time when the graphic elements were being recorded.

### CROSS REFERENCE TO RELATED APPLICATION

The present application is a continuation-in-part of U.S. patent application Ser. No. 10/635,756, filed Aug. 5, 2003 for which priority is claimed.

### FIELD OF THE INVENTION

The invention relates generally to computer systems, and more particularly to a system and method of recording and replaying events in a computer environment.

### BACKGROUND OF THE INVENTION

Animation is the creation of media using picture files, e.g., jpeg, tiff, etc., where these files are organized according to set numbers of frames which represent set periods of time, typically 24, 25 or 30 frames per second. In addition, these files are organized according to layers, each new layer being progressively higher than the one before. Various animation programs have been developed for the personal computer over the last decade or so and they all utilize frames and layers to some extent.

Automation has been used extensively in the entertainment industry, notably, the audio industry for over 20 years. The most popular use of automation is the recording and playing back of moves made with various devices on recording consoles. The most popular devices to automate are faders and switches, but knobs have also been automated on many different types of recording consoles. Automation for recording and playing back audio migrated to the personal computer nearly two decades ago and many companies have offered versions of software that can automate graphic devices, and physical devices that exist outside the computer as stand alone control surfaces. Automation is also used in video production consoles and film and post production consoles. A common thread among automation systems is the ability to record and play back moves made on devices that are controlling something. In the case of entertainment consoles, that something is always some type of media.

Automation has been used also in industry. Examples would be controlling pressure valve or flow valves in processing plants. These automation system are quite complex, but they still perform the function of recording and playing back moves made on devices.

A wide variety of animation and automation systems have existed for over two decades in computers.

### SUMMARY OF THE INVENTION

A system and method for recording and replaying property changes on graphic elements in a computer environment provides a user with the ability to record his/her interactions with controls in the computer environment and then to replay these interactions. Both graphical and functional information are recorded for all objects in the computer environment such that, during replay, the recorded graphic elements are actually being interacted with in the same manner as during the time when the graphic elements were being recorded.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows a diagram of the Drawmation architecture.

FIG. 2 illustrates how Drawmation preserves the relationship between objects.

FIG. 3 illustrates the use of animation to demonstrate the relationship between objects.

FIG. 4 illustrates a series of images that are played one after the other to create an animation.

FIG. 5 illustrates how Drawmation records change state of a red star.

FIG. 6 illustrates the various concepts surrounding the Replay Cycle.

FIG. 7 illustrates a mouse press flowchart

FIG. 8 illustrates a mouse move flowchart.

FIG. 9 illustrates a mouse release flowchart.

FIG. 10 illustrates a replay diagram.

FIG. 11 illustrates a start replay flowchart.

FIG. 12 illustrates a normal replay flowchart.

FIG. 13 illustrates a fast forward replay flowchart.

FIG. 14 illustrates a rewind replay flowchart.

FIG. 15 illustrates a placing the cursor flowchart.

FIG. 16 illustrates a make cache flowchart.

FIG. 17 illustrates how the dimensions change when setting the DM geometry of a cropped picture.

FIGS. 18a-18c illustrate looping play bar segments in a Drawmation session.

FIG. 19 illustrates a flowchart for creating a film.

FIG. 20 illustrates the creation of a film using the blue “sequence” arrow.

FIG. 21 illustrates a flowchart for cropping pictures.

FIG. 22 illustrates a flowchart for loop recognition.

### DETAILED DESCRIPTION

A system for recording and replaying graphic elements in a computer environment (referred to herein as “Drawmation”) in accordance with an embodiment of the invention provides a user with the ability to record his/her interactions with controls in the NBOR Environment. The term “NBOR” is a trademark of NBOR Corporation, as well as the terms “Blackspace”, “VDACC” and “Info Canvas”, which are also used herein. For the purposes of this disclosure, the terms “NBOR environment” and “Blackspace environment” are used interchangeably. Drawmation records both graphical and functional information for all objects in Blackspace.

Terminology

User Interface

The user interface is the top most software layer responsible for transferring information to and from the user. The Blackspace Desktop (Primary Blackspace) is the main user interface.

Context

A context is the implementation of a group of functionally related tasks. A context abstracts these tasks so that the other contexts are unaware and do not care about how the task in question is implemented. For example, a context that controls the air conditioning in a building will delegate the actual tasks of heating and cooling to the building's existing systems and act as a proxy on behalf of those systems. On the other hand, a mixing desk context may actually provide the sound processing elements, as well as controlling them (e.g. the Sound Context).

Contexts also interface to the outside world. For example, the Sound Context interfaces to the sound card, the GUI (which is also a context) interfaces to the video hardware.

The NBOR Environment

The environment in which the contexts and the user interface operate is a combination of native operating system(s) facilities, standard networking protocols and ‘glue’ to enable all the components to work together.

A Context Message

A context message is an autonomous entity in the NBOR environment. It has a lifecycle just like any other object. Unlike a standard protocol packet, the message object contains functionality as well as information. This functionality includes:
i. House keeping operations used by the environment
ii. Stream to XML for transmission between NBOR environments
iii. Construct from XML on reception from another NBOR environment
   Sessions

The Current Session is the Drawmation Session that the user has selected for editing. A Loaded Session has been loaded into memory from a session file stored on the computer's hard disk.

Drawmation Architecture

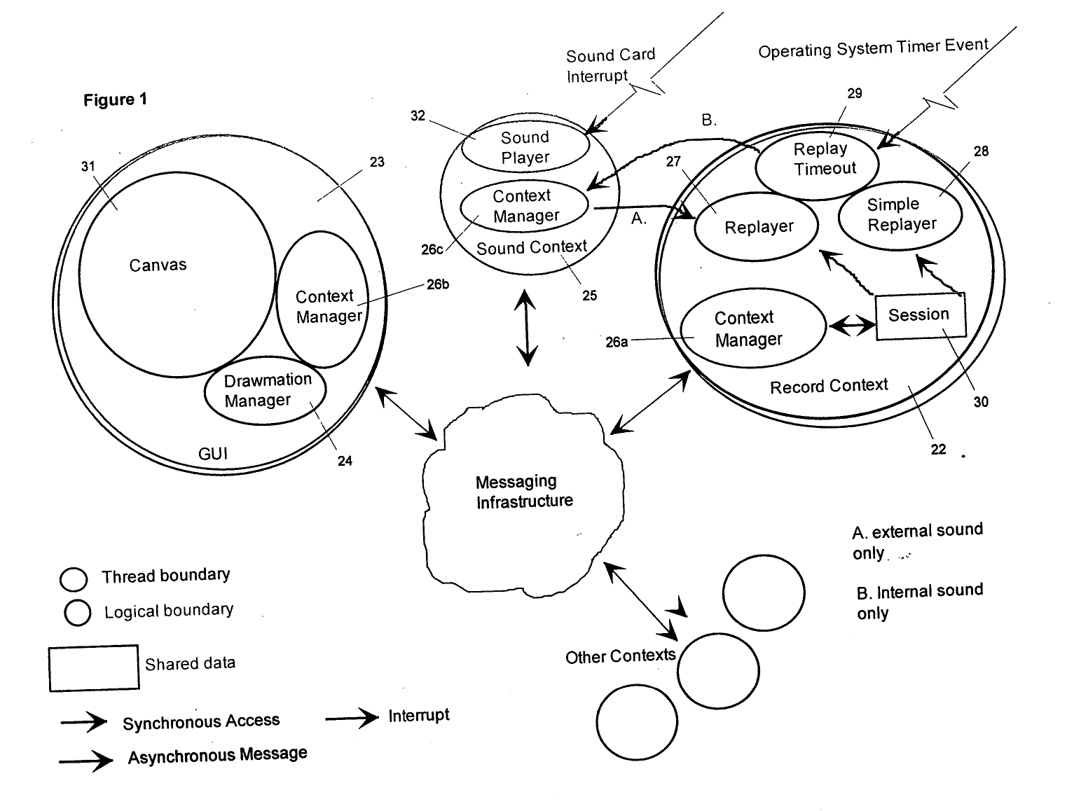

FIG. 1 shows a diagram of the Drawmation architecture. Drawmation functionality is performed primarily in the Record Context 22. A smaller component of Drawmation resides in the GUI 23; the Drawmation Manager 24. Drawmation also receives interrupts directly form the Sound Context 25 and the Operating System.

Although Drawmation can be used for any control in the NBOR environment, it is typically used in conjunction with controls in the GUI. In order to simplify this disclosure, no reference is made to controls in contexts other than the GUI but the principles of operation remain the same for all contexts.

A logical boundary groups functionally related areas of the system. A thread boundary defines the extent of a separate thread of execution. Threads are supported and managed directly by the operating system. All threads within a process have access to the same address space in memory. This means that they can share the same code and data.

Record Context

The Record Context 22 lies at the heart of Drawmation. It provides all the functionality to record and replay context messages in an orderly and timely manner. These context messages contain information about the properties of controls in the GUI 23, either a snapshot of the control's state or a change in property as a direct result of user interaction with the control

Context Manager of Record Context

The Context Manager 26a controls every aspect of Drawmation. It manages all the Drawmation data, stored in a session, and performs all the necessary functions to record, edit, save and restore that data. The Context Manager 26a implements the state machine that governs the operation of Drawmation. This state machine determines when and how Drawmation can be used. For example, Drawmation data cannot be edited while a session is being replayed. The Context Manager 26a enforces this rule.

The Context Manager 26a creates two software objects to replay Drawmation data, the Replayer 27 and the Simple Replayer 28. A third object, the Replay Timeout 29, is created to supply the players with timing information. The Context Manager 26a controls the operation of these players, including the scheduling of which sessions to play and when.

The Context Manager 26a delegates some tasks to the Drawmation Manager 24 that resides in the GUI 23 but it still maintains overall responsibility for Drawmation. If the GUI were not provided, Drawmation would still be available to the other contexts.

Replayer

The Replayer 27 is responsible for replay of the Current Session. The Replayer is able to play forwards and backwards through the Current Session. The Replayer may play forwards through the Current Session at normal playback speeds or at high speed. The Replayer rewinds through the Current Session at high speed.

Simple Replayer

The Simple Replayer 28 has the capability to play multiple Loaded Sessions. The start times of these sessions may be offset, with respect to one another, according to when the user requests replay for each session. The Simple Replayer can only play forwards through sessions at normal speeds.

Replay Timeout

The Replay Timeout 29 maintains time on behalf of the Replayer and Simple Replayer. The Replay Timeout may be driven directly by the Sound Context (if there is audio data to play) or by a timer provided by the operating system.

The operating system timer is configured to generate a regular interrupt. On receipt of this interrupt, the Replay Timeout 29 determines the elapsed time since the last timeout and then requests the players to replay data for this interval.

If the Replay Timeout 29 is configured to use timing information from the Sound Context where the Player 32 is running in a separate executable, the Repay Timeout is driven directly by the Context Manager 26c in the Sound Context 25. If the Player is running in the same executable as the Replay Timeout, the Replay Timeout is driven from the Operating System interrupt but obtains timing information by reading the sample clock on the sound card via the Context Manager 26c in the Sound Context 25. In this way priority can always be given to the Player. (See the Sound Context section below for further information.)

The Replay Timeout 29 scales the elapsed time according to the user selectable replay speed (default x1).

Session

A Session 30 is all the recorded data for a group of controls. The Session content is ordered on a ‘per-control’ basis. The data for each control is also in time order. When the user selects a Session, the Context Manager 26a loads it into memory. The Session is read and written by the Context manager. It is read by the players.

GUI

The GUI is the thread responsible for all graphics related operations. This is the user's primary interface to the NBOR environment.

Canvas

The Canvas 31 manages the graphical display. Controls are rendered on its display surface (Blackspace). The Canvas delegates user input, such a mouse events and keystrokes, to controls. In turn the controls perform some function in response to this input, which may result in a change in their graphical appearance. Controls report any changes in state to the Context Manager 26b.

Context Manager of GUI

The Context Manager 26b provides the interface between the GUI 23 and the NBOR environment. The Context Manager 26b translates synchronous notifications of property changes on controls in the canvas into asynchronous messages for delivery to other contexts.

The Context Manager 26b receives messages from other contexts and either performs the request directly or passes that request onto the intended recipient.

Drawmation Manager

The Drawmation Manager 24 performs operations on behalf of the Record Context 22. It is an extension of the Context Manager 26a functionality specifically for Drawmation. It constructs Drawmation specific messages and manages a cut down version of the Drawmation state machine.

Sound Context

The Sound Context 25 provides audio facilities in the NBOR environment.

Context Manager of Sound Context

The Context Manager 26c controls the Player 32. It is responsible for configuring the sound-processing network, in response to User requests received from Blackspace. The Context Manager 26c either runs within the main application or in a separate application.

Player

The Player 32 is a separate thread that drives the sound hardware. The Context Manager 26c controls the Player. The Player reads data from disk, performs any required processing on that data and writes the results to the sound hardware.

The Player 32 also maintains a sound clock, which keeps track of time by reading the number of samples played by the sound hardware since replay started and dividing this by the sample clock frequency. The Player also maintains a sample offset, for use when replay starts later than time zero. The User selects the replay start time by clicking or dragging the play cursor on the timeline.

Operating System

The Operating System provides a layer of abstraction between applications and the computer's hardware. It provides system wide services to all applications. Drawmation uses the Operating System to provide timing information for use during recording and replay.

Using Drawmation

Drawmation can record both the graphical information about every object in Blackspace as well as recording functional data and/or operational data associated with each of these objects. As an example, Drawmation is capable of recording and playing back information for the following:
The creation of graphic objects and devices, which are referred to as controls.
The object definitions for these controls.
The actions caused by operating these controls.
Contexts Links and associations pertaining to these controls.

Drawmation records and replays (plays back) the drawing of any recognized object or the creation of any device, for example a switch, e.g., by using Object Points (see pending U.S. patent application Ser. No. 10/103,680, entitled “Method for Controlling Electronic Devices Using Object Point Tool”, filed on Mar. 22, 2002, which is incorporated herein by reference). Drawmation records and replays physical positional changes for each of the objects in Blackspace. For instance, a star or a fader could be at certain X and Y coordinates in Blackspace and then be moved to a new set of coordinates. Drawmation records physical state changes for each of the objects in Blackspace. For instance an object could be visible for a period of time and then become invisible.

Drawmation records and replays actions that are caused by controls. For instance, if a green triangle has a document assigned to it, the touching of the green triangle causes the document to appear onscreen. Drawmation records and replays the touching of the object and the resulting action.

Drawmation records and replays actions that are caused according to certain contexts and links. For instance, if a red “control” arrow is drawn from a fader to another fader, the first fader will be control the second. But if that same red arrow is drawn from a VDACC to another VDACC and then text is typing into the first VDACC, that text will automatically wrap to the second VDACC when it hits the bottom of the first VDACC. This is a different context for the same action “control” of the same device, a red arrow.

What are some of the specific things that Drawmation records and plays back?

Drawmation itself has the capability to record any property on a control in Blackspace. The framework is there to support recording any property.

Drawmation records at least the following properties: border color, geometry and position, value changes, e.g., moving a fader cap or turning a knob, location, it records the association of objects, e.g., who is the parent and who is the child with regards to VDACCs and IVDACCs and the objects in their graphic linkers, so it records the relationship of one object to another. Being a parent or the object that owns another object is recorded as just another property of that object. Animation doesn't know anything about this. Objects are pictures assigned to frames and they have no relationship to one another as functional objects.

Clipping is another property that is recorded in Drawmation as part of an object. Drawmation records the object's definition and any changes to that definition. Drawmation records all changes to the properties of objects in Blackspace. Drawmation doesn't make any distinction between these properties. It just records them and plays them back.

Regarding context, Drawmation saves linkers. The relationship of one object to another is saved as a separate object by Drawmation. Accordingly, Drawmation saves linkers as a separate object. Drawmation records changes in both the source and the target objects.

So the linker is just another object which can be recorded in Drawmation. The linker is a completely separate entity which is recorded in Drawmation.

Linkers live in the GUI. Drawmation monitors the state of the GUI to keep track of what's new, what's not, what's available for recording and what's not available. It keeps a running record of everything that happens on any object that it can record information for.

In Blackspace, there are objects and there are relationships between objects. The relationship (linker) is a valid entity in its own right and it can be recorded and replayed with Drawmation.

Drawmation also records things like scrolling, scaling, e.g., resizing a photograph or graphic image in Blackspace. Drawmation records conditions like brightness, contrast, hue, saturation, color changes, etc. It records DSP like equalization, echo, panning, compression, delay, etc.

Drawmation records Z-levels, the layer of an object, and it records any changes in the Z-level of objects.

Drawmation records the parent/child relationships of objects. For instance, if a user drags a number of objects into a VDACC and then moves that VDACC, Drawmation records the movement of the VDACC and all of the items contained within moving along with it and replays this all back exactly as it was moved in Blackspace by a user.

Drawmation records assignments and the operation of objects that have assignments to them. If there exists a relationship like a control group (an assignment), that's an association. For instance, if you assign a group of objects to a star object, these objects are not physically contained by the star. If you move the star around you don't move the items that have been placed inside the star. They stay where they originally were when they were assigned to the star in the first place. In this case, the star moves, but the objects assigned to it do not move. The nature of an assignment is not to cause the assigned objects to be contained by the object they are assigned to, in the sense that the moving of that object moves the objects assigned to it.

Drawmation allows its users to manipulate real objects.

Blackspace objects are operable by a user. This is in sharp contrast to an animation system where there exists only representations of objects, e.g., pictures of an object.

With Drawmation for example, you're manipulating real faders and real switches and folders, and operational devices. With animation you're manipulating photographs of devices. You can't operate the devices because they are just images. Animation is a purely visual experience.

What's the definition of real object? These are real objects within the context of Blackspace. When you Drawmate a switch, it's a real switch. It's a real Blackspace switch. If you are trying to animate something, it's not a real anything. It's just a set of pixels. You can't click on it and have some underlying function be performed.

Animation is a purely visual tool (maybe with audio accompanying it). All that is being created is a visual experience that is viewed by a user with or without a soundtrack or narration.

With Drawmation the approach is much more closely aligned to automation. You not only get a visual appearance and effects for the benefit of the user, but you can also record physical changes on devices and have those devices hooked up to any sort of network or control anything that can be controlled by a computer.

There is no limit to what these devices can control because they are real devices. There is no way of doing this in animation.

Drawmation offers an automated control surface. Drawmation doesn't really compete with animation, rather it is significantly expanding the scope of automation. Drawmation is not restricted to automating just value changes. It can be used to automate a whole range of properties for devices.

Drawmation is operated on a global drawing surface.

Drawmation is simply another tool available to the user in Blackspace. Therefore, the user is able to take any of the objects in Blackspace (Primary Blackspace desktop) and start manipulating them in Drawmation.

Drawmation is there to be used immediately without requiring a user to learn a new interface, or needing to learn a new tool or a different mind set, because it simply records and replays what a user is already doing.

When a user Drawmates a move on a fader it will play back the way that the user moved the fader's cap up and/or down. If the fader is moved from one location to another, as a graphic object, there is no learning curve, because Drawmation records the utilizations and manipulation of objects on a user's desktop (Blackspace) which is the normal working environment of the user.

Drawmation is seamlessly integrated into the Blackspace environment.

Drawmation is a Blackspace tool that is available just like any other tool in Blackspace. What the user is given to manipulate and operate Drawmation with are the same objects that the other tools in Blackspace use.

When a user wants to Drawmate a piece of text, it's that piece of text that the user Drawmates. The user does not have to go and take pictures of that piece of text. The user do not have to go and render that piece of text in a different tool. The user just uses that piece of text directly in the environment in which the user is working right now, namely, Blackspace.

There is no need for a user to leave his/her current work environment to make use of the Drawmation tool.

Drawmation is one of many tools that are globally available in Blackspace.

Blackspace is a collection of tools that are available for the user to make use of however the user sees fit. Drawmation is one of these tools. Blackspace places minimal constraints on its tools and Drawmation is no exception. Drawmation simply records and replays what exists in Blackspace, e.g., the ability to create and program controls (objects and devices) and to perform functions with these controls.

Drawmation can be used to record and replay controls for any purpose. For instance, if someone wanted to integrate an air-conditioning unit, for example, Drawmation could be used to record changes in the air-conditioning controls. If a user wanted to record the button presses and fader moves for operating a piece of computerized machinery, Drawmation can record all of these events and play them back perfectly.

As far as the record context in Blackspace is concerned the GUI is just another context that has objects in it that can be recorded and played back. Drawmation does not distinguish between any of the objects in Blackspace, as if to say, “this is a graphical object or this is a real physical device.” If it's something that has property changes a user can employ Drawmation to record it and replay it.

There's no real ownership of property changes in Blackspace. An object has what we would term a “state,” which is at any point in time the values of all the properties for that object. For instance, consider a Blackspace fader. It has a location, it is set to a value, etc. These factors represent the state of this object at any point in time. Drawmation is able to say “OK at this point in time the state of this object should be this and I will record these properties as they change.” The record context is able to replay them back upon demand in a timely and orderly manner.

Drawmation is effectively infinitely layered.

There are no constraints on how many data streams you can have running in parallel. The limiting factor is the memory and the speed of the processor in a user's computer. But there is nothing in the structure of Drawmation that says you can only have a certain number of controls at one time.

How is this infinitely layered system supported in Drawmation? Each control or object in the GUI has its own chain of history, has its own private history of the events that are being recorded for that control. And then there's a container that reads through those histories together as a Drawmation.

These histories are managed on behalf of the objects in the GUI. They are completely separate. Because there's no real constraints on who or what creates the object that Drawmation can record. These objects don't have to be GUI based. They could be objects that are owned by a sound player or objects that are owned by an air-conditioning system.

Users can start from an entirely blank canvas (drawing surface) and use Drawmation to record the creation of controls and then the operation of these controls.

Computer programs have boundaries and their applications do not extend beyond those boundaries. Blackspace encompasses all of the user's working environment. There is no need to leave Blackspace to do one's work. All work happens in Blackspace.

Blackspace is essentially a free form environment in which to work. Blackspace is like a blank sheet of paper. Largely unlimited by the constraints or rules and regiments imposed by a programmer writing a software program. Blackspace is designed to work the way people think, not the way computers traditionally constrain them to think. Blackspace brings a flat and static work environment to life. It introduces the ability to have dynamic behavior as well as static layout both as part of a user's working environment.

On a blank canvas, animation and automation software can record and do nothing. On the same blank canvas Drawmation can record and replay the creation of all objects that can be created in Blackspace. From a user's point of view' Drawmation can be operated with no apparent structure. It just records and plays back what the user does in Blackspace.

Drawmation records controls (graphic objects and devices) anywhere on a global drawing surface. There are no partitions here where Drawmation cannot work. Literally every pixel on the global drawing surface is Drawmatable (capable of being recording and replayed by Drawmation).

Drawmation can be used to record and replay the transformation of a purely graphical object into a functional object. For instance, a picture exists as a purely graphical object. But it can be lassoed and turned into a password (see pending U.S. patent application Ser. No. xx/xxx,xxx, entitled “Method for Creating and Using Computer Passwords”, filed on Aug. 5, 2003, which is specifically incorporated by reference herein). Then this picture becomes a functional object, an object that causes an action. In this case, the picture can be used to lock (password protect) an item or unlock a previously password protected item.

Drawmation is a tool for programming a user interface. Drawmation can be used to record and replay changes in the basic function of a device. For instance, a fader could be a volume control for 15 seconds and then become a brightness control. This could be accomplished by recording and replaying the typing of the word “volume” next to a fader and then 15 seconds later typing the word “brightness” next to the same fader.

Drawmation versus Animation.

Drawmation breaks away from the dependency on frames that animation has. Animations are very rigid in structure. Everything happens on particular time intervals. Images have a lot of constraints on them when they occur and they are subject to a strict layering structure—what row of frames goes on top of what row of frames, etc.?

In an animation software system, there are lots of dependencies between frames. If a user wishes to change something in one frame the user needs to understand how this will affect all of the frames before and after it.

By completely removing the need for frames and using real objects instead of graphic images, users of Drawmation don't have to contend with any of these issues that plague animation systems. In Drawmation, if a user wants an image to be in a different place at a different time, the user just moves it to a different place at a different time. If the user wants an object or device to be in a different state at a different time, the user just changes the state of that object or device at that time. So from this point of view, Drawmation is virtually infinitely flexible.

Animation is the creation and replay of a series of images that illustrate the motion of objects. The images do not contain any objects themselves, they are just a pictures of how the real objects were rendered at a particular point in time.

Drawmation is the recording and replaying of events on objects. On replay the user sees a real object and the recorded operations being applied to it. Events are recorded as they occur, so if the object remains static for the duration of the recording, there is nothing recorded after it's initial state.

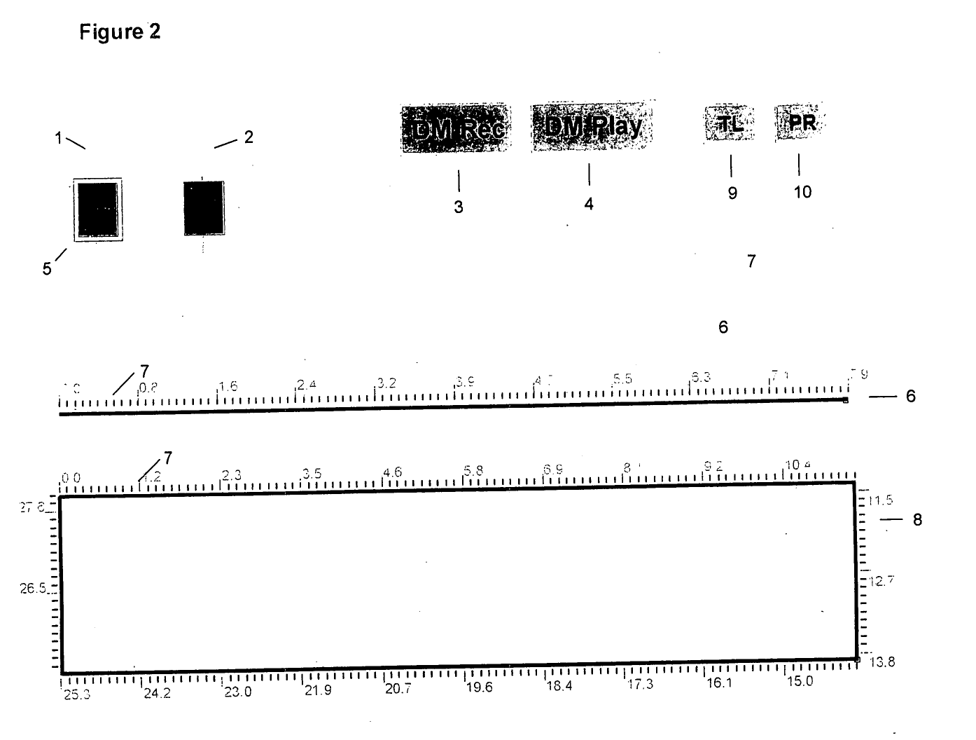

Referring to FIG. 2, Drawmation preserves the relationship between objects. The right fader 2 is a slave to the left fader 1. This link was created by dragging a red “control” arrow (an arrow that applies the arrow logic, “what the arrow is drawn from controls what the arrow is pointing to”), from the left fader and then pointing it to the right fader.

Let's say a user wants to demonstrate this relationship between the two faders. In Drawmation, the user would record:
i. The initial conditions (left fader, right fader, linkage between faders)
ii. The value changes on the left fader.

The user turns on a DM Rec switch 3 which automatically turns on the DM Play switch 4. Then Drawmation starts to both play and record. Note: To activate Drawmation for the first time a user can turn on a DM Rec switch, for example, by left-clicking on it. When the DM Rec switch turns on, the DM Play switch turns on. To navigate through the Drawmation, two types of timelines are available: (1) a Blackspace linear timeline (BTL) 6, and (2) a Play Rectangle timeline (PR) 8. On each timeline is a play cursor 7 which moves along each time line as the Drawmation records and later replays its recorded information. The play cursor on both timelines will move in sync with the current Drawmation that is either recording or replaying. To call forth the linear timeline a switch can be created using Object Points and then the letters TL are typed on the switch 9. When this switch is turned on, the linear timeline appears. Similarly, creating a PR switch 10 and activating it brings the Play Rectangle to the screen. Any number of BTL and PR timelines can be created for a single piece of media.

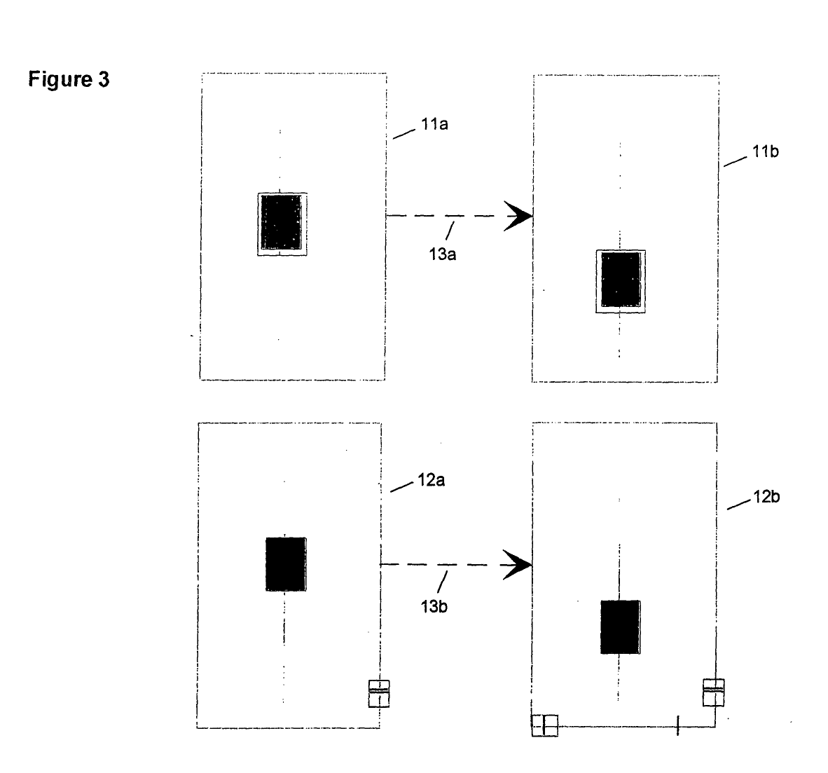

By contrast, if a user wished to use animation to demonstrate the relationship between the two faders in the above example, the user would record at least the following images as shown in FIG. 3:
i. The image of the first fader in its first position 11a.
ii. The image of the second fader in its first position 11b.
iii. Multiple images added in between image 11a and image 11b, depending upon how smooth of a movement is desired in the animated movement of this fader image. This is shown as 13a.
iv. The image of the first fader in its second position 12a.
v. The image of the second fader in the second position 12b.
vi. Multiple images added in between image 12a and image 12b, depending upon how smooth of a movement is desired in the animated movement of this second fader image. This is shown as 13b.

In addition, not shown in these figures is the parameter number above each fader that shows the position of the fader. In an animation, this number would have to be animated with a completely separate group of images for each of the faders.

Drawmation and animation are completely different. Animation is the creation and replay of images. Drawmation is the recording of property changes on actual objects and functional devices. Animation shows an object being moved, altered, changed, etc. Drawmation actually recreates the moving, alteration and changes to the object. Furthermore, Drawmation recreate the creating of the object and/or device itself.

Referring again to FIG. 2, item 1 is a functional graphic fader. It can be moved and operated. Nothing more is required in order to Drawmate the movement or operation of the fader other than turning on the DM Rec switch and moving this fader. Referring to FIG. 3, item 11 a, this is an image of a fader. It is not a functional device, it is a picture. In animation, the movement of this fader 11a is achieved by showing this image in a different position in subsequent frames 13a. The visual appearance of operation is achieved by showing a different image, with the fader cap in a different position and the value label reading a different value, for each step in value in subsequent frames.

Another way of thinking about the relationship is to consider an object that displays images. Drawmation records the image displayed by the picture control. If the picture control shows a series of images (an animation for example) the Drawmation records these property changes and can replay them. Therefore, Drawmation has encapsulated the animation completely in the Drawmation data for a single control.

Effectively, when a user drags an object and records this action in Drawmation, this creates a set of instructions which can be replayed to perform that operation at some point in the future without any user interaction. All the user has to do is hit play and the objects will move without having to touch the mouse any further.

If one were creating an animation of this same process, all he/she would have is a graphical representation and that would not be the same as moving a real object. What one gets with Drawmation is the marrying of the visual effects of animation with the functional effects of automation into a single environment that is completely integrated with Blackspace.

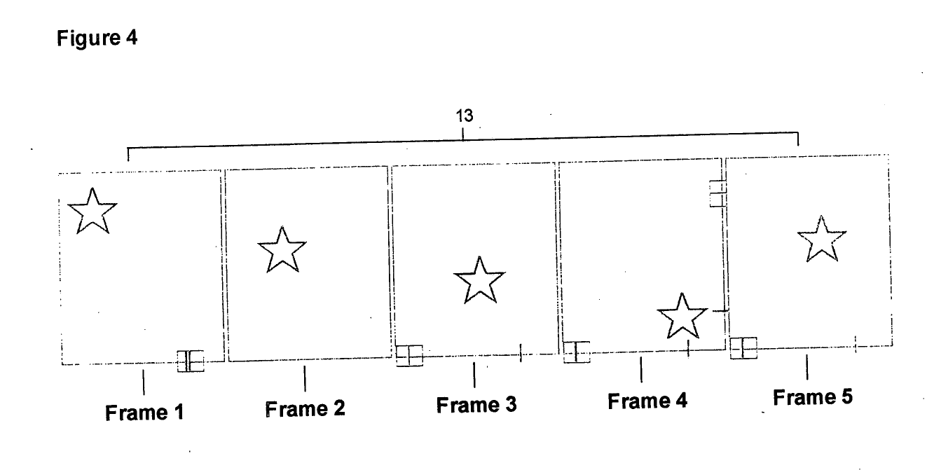

Referring to FIG. 4, a series of images 13 are played one after the other to create an animation. Animation is the creation and replay of a sequence of images that reference to fixed time units called frames. The images neither contain objects themselves nor can they be operated.

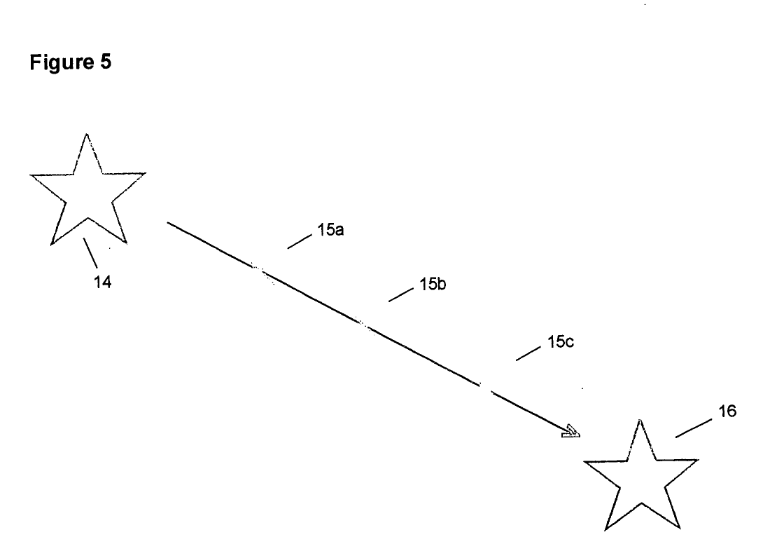

Referring to FIG. 5, Drawmation records the initial state 14 of a red star. The star is dragged across the screen. The mouse generates “n” movement events, each of which moves the star. Drawmation records the position of the star at the end of each incremental move, e.g., 15a, 15b and 15c. The user releases the left mouse button to complete the drag. Drawmation records the changed state 16 of the star.

Further regarding FIG. 5, Drawmation is the recording and replaying of events on objects. On replay, the user sees a real object and the recorded operations being applied to it. Events are recorded as they occur, so if the object remains static for the duration of the recording, there is nothing recorded after it's initial state.

What's different between Drawmation and an automation system in a recording console? There are objects in the GUI that only have meaning in the GUI. There are other objects in the GUI that have meaning outside of the GUI. For example, a VDACC has no purpose outside of the GUI. It's purpose is to provide information within the GUI, to provide a tool within the GUI to the user. But if you have a fader that is acting as a volume control, not only does it have a visual presence in the GUI, it has meaning to another part of the system.

Drawmation enables users to record and replay moves/changes made for any operable device in Blackspace, e.g., a fader cap, a rotatable knob, an actuatable switch, a 5.1 surround panner, etc. But at the same time, the graphic element of each of these devices can be independently recorded. Thus a user could have a fader appear in location X for a period of time and then appear in location Y.

Furthermore, the functionality of devices in Blackspace can be recorded and replayed in Drawmation. For instance, a fader could be a volume control for a period of time and then become a brightness control and then turn into a pan control or color control, etc.

In addition, different arrow logics can be applied to this fader over time and the application of these arrow logics can be recorded and played back in Drawmation. For instance, this same fader could have a “control” arrowlogic applied to it where it is controlling other faders. Then this arrowlogic could be “erased” and a “send to” logic could be applied to this fader where it is functioning as a sub-mixer to one or more inputs controlled by other faders. The applying of the first arrowlogic, the “erasing of it” and the applying of the second arrow logic can be recorded and played back in Drawmation.

Blackspace Glue.

One could also argue that glue is a container. Because when you move one object that is glued, all of the other objects glued to it also move. Glue is a software object. It is itself a linker.

In Blackspace, just about everything in the GUI inherits from a base class and has properties that are general across every object. And one of those properties is an-ID. This is basically a long number unique to each object that identifies each object in Blackspace. This ID is common in the art.

Glue itself has an ID number, so it can be used as a separate graphic object.

Drawmation Design

Drawmation is the process of recording and replaying property changes on controls in Blackspace.

Definitions

Controls

A “control” is any object or device that can exist in Blackspace. Controls are the graphical elements on the Blackspace drawing surface that the user manipulates. Graphic objects include stars, rectangles, ellipses and check marks, and graphic devices include switches, faders, knobs and joysticks.

A control can be anything that has a uniquely identifiable purpose for the user in Blackspace. For example, a fader is a control, but the labels, cap and groove are not. Instead, they are the components that the control uses to represent itself graphically. The purpose of a fader is to contain a value and provide a means by which the user can adjust that value.

NBOR Environment

This is the processing architecture that enables controls to be presented to the user, to be manipulated by the user, to communicate with one another and to communicate with contexts. A control has a lifetime within the NBOR environment.

The use of the word “lifetime” refers to when a user creates an object for his/her use and then the user deletes it when the user is finished with it. The time in between is its lifetime. It exists between its creation and its destruction.

Application boundary.

When you start an application on Windows for example, it has an address space that is private to the application, and anything outside of that boundary cannot access the memory allocated to the application. Anything inside that application cannot reference memory outside of the boundary. All the controls in Blackspace exist within the application boundary.

Contexts

A context is a processing entity that performs one or more related functions for the benefit of the user. For example, an air conditioning context could control the climate in a building. The sound context plays and records audio. The contexts are the components of the system that communicate with the outside world. The contexts use controls to represent their functionality to the user.

Contexts implement the rules that govern the behavior of objects in a related functional area. Contexts are implemented as separate threads of execution and operate independently of one another, performing tasks on behalf of the user.

Each context is responsible for managing a particular type of interface to the outside world. For example, a sound context talks to the sound hardware; the GUI talks to the screen. The GUI is also a context because it provides the interface to the computer's graphics hardware.

Communication

Communication between contexts, including the GUI, is achieved using messages. These messages are delivered to the recipients by the Message Broker. The Message Broker is the software entity that transports messages between contexts and notifies contexts of message delivery. The Message Broker is also responsible for all housekeeping operations on messages, such as creation and deletion after all contexts have acknowledged reading the message.

Contexts register an interest in a particular type of message with the Message Broker. There are a large number of message types sent between contexts to control the operation of Blackspace. Create, update, and modify messages contain information relating to control properties. Create messages contain sufficient information to recreate the control from scratch. Modify messages contain a single property change and update messages contain the state of one or more properties. A modify message implies that the user has performed an operation on a control. An update message is used to identify the state of the control at a specific point in time. Drawmation records these messages in the Media Layer.

Transactions

A transaction is the sequence of events that begins with the user pressing a mouse button and ends when the user releases that mouse button. A transaction may include intermediate mouse moves.

The user pressing a switch or selecting a picture with the mouse and dragging it are examples of transactions. In both cases the user's actions begin with a mouse button press and end with the release of that mouse button.

Drawmation Data

Storage of Drawmation data and access to this data is modeled on the way files are stored and accessed on a hard disk.

Drawmation data is comprised of property changes on Blackspace controls. For example, the Drawmation data includes the different values generated when the user drags a fader cap. Any control in the Blackspace environment can be drawmated, with the exception of those controls that change the global behavior of Blackspace, such the DM Rec or RDraw switches.

Drawmation does not store the original mouse events because Drawmation is not restricted to the recording of property changes on graphical controls. By storing the results of user interactions, Drawmation can support multiple graphical representations of controls, dependent on the country of use and the physical constraints of the interface. These implementations may differ in how they are operated by the user but the Drawmation data relating to functional properties will still be valid. For example, no matter how a fader is represented graphically it will always have a value property.

The changes on an individual property can be plotted graphically, with time on one axis and the property value on the other. Drawmation provides a mechanism to read these points sequentially using the descriptor layer. Drawmation provides a mechanism to read these points with respect to time using the generator layer. Drawmation provides a mechanism to read blocks of these points using the stream layer.

Media Layer

Drawmation data is stored in the Media Layer. The Media Layer is analogous to the audio information stored in a sound file (e.g. files with a .wav file extension on Windows) on disk. When a Drawmation session is loaded, all the Drawination data contained in that session is loaded into memory in order to optimize the speed of access to the data.

Data Access

Access to the Drawmation data is implemented using a layered architecture. Each layer builds on the functionality of the layer below it and provides additional facilities to the layer above it.

Descriptor

The descriptor layer is responsible for accessing the media layer directly. The descriptor layer provides a mechanism for accessing the media layer in an orderly manner.

The descriptor layer is equivalent to the way that file descriptors, provided by the operating system's Application Programming Interface (API), are used to access files stored on a hard disk. For example, a file descriptor is opened up when a user opens a file on a hard disk. The file descriptor initially points to the first entry in the file. Each time data is requested from the file descriptor, it reads data from the file sequentially. There is no concept of time in this layer.

Generator Layer

The generator layer uses time to select data to retrieve the data from the media layer, using the descriptor layer. This allows Drawmation to retrieve data by specifying that the generator should provide all data up to a specified time.

Different types of generator layer can be used to provide additional filtering or automatically generate events on the fly according to rules specific to that type of generator. The default generator simply passes data read from the descriptor layer straight through but more sophisticated generators can be used to provide additional functionality without affecting the original Drawmation data.

For example, a cross-fade could be recorded as a sequence of value changes, or a single cross-fade event could be recorded. A generator that implemented cross-fades would automatically generate value property changes on retrieving a cross-fade event from the descriptor layer on the fly.

Stream Layer

The stream layer provides the facility to aggregate property changes into a single event for a specified time interval (e.g. fast forward or rewind). For example, if the media layer contains multiple value changes for a specified time interval, the stream layer can filter out all but the last property change. The stream layer is able to combine multiple types of property change into a single event, thereby dramatically reducing the messaging traffic between the Drawmation replayer and the context that owns the control to which this event relates. This facility is used in Fast-Forward and Rewind modes.

Note: Fast-Forward and Rewind are the terms used to describe clicking on the play cursor and dragging it along a timeline. Dragging later in time is fast forward. Dragging earlier in time is rewind.

The Stream Layer selects the type of generator to use for subsequent data retrieval, based on the data previously retrieved from the media layer.

Drawmation Session

A Drawmation Session is composed of the property changes that are associated with one of more controls. These property changes are recorded over a known time interval.

The Drawmation Session provides access to the media via the Stream Layer. The Drawmation Session provides a single composite stream of information for use during replay.

The individual Drawmation Sessions are saved in separate files on the disk. When the user saves a log, references to the currently loaded Drawmation Sessions are saved in the log. In addition, the replay speed factor, the replay start time and the current replay time are stored in the log, along with the filename and path of the session file.

The Drawmation file browsers allows the user to navigate through the file system to locate the Drawmation Session the user is interested in. Once the session has been located, the user can double click on the appropriate entry in the browser to load the Drawmation Session.

Property Changes

The NBOR architecture is partitioned into the number of contexts. When the user adjusts the property of a control in the GUI, the result of that change is broadcast to the other contexts. In many cases, a user interaction indirectly affects other properties of the selected control and other properties of linked controls. In all cases, a single property change is broadcast to the contexts, since all the other property changes can be inferred. This reduces the messaging bandwidth and ensures that on replay there are no conflicts between controls responding to messages.

If there is a parent/child relationship, property changes on the parent are broadcast. For example, if two objects are glued, the user cannot drag the glue because it has no graphical representation. Instead, the user drags one of the glued objects but the drag is performed on the glue, which moves all the controls it contains. Drawmation records the property changes relating to glue control. There is no need to record the property changes on the glued controls because, on replay, these property changes will be automatically regenerated by the glue control. This simplifies the replay logic and minimizes the messaging bandwidth.

The Property Changes are the Drawmation data. The information is stored in the media layer. For example, if a user moves the cap of a fader such that on the mouse press the value was fifty and on the mouse release the fader has changed to sixty, the fader has a value property that at the start of the move, was fifty, and has a value property at the end of the move, which was sixty. In between, there is one value property change for each mouse movement generated by the underlying operating system. Each of the property changes are time stamped, assigned a unique id, and assigned a transaction number. This information is used by Drawmation to group property changes together for presentation to the user as the Playbar.

Replay Cycle

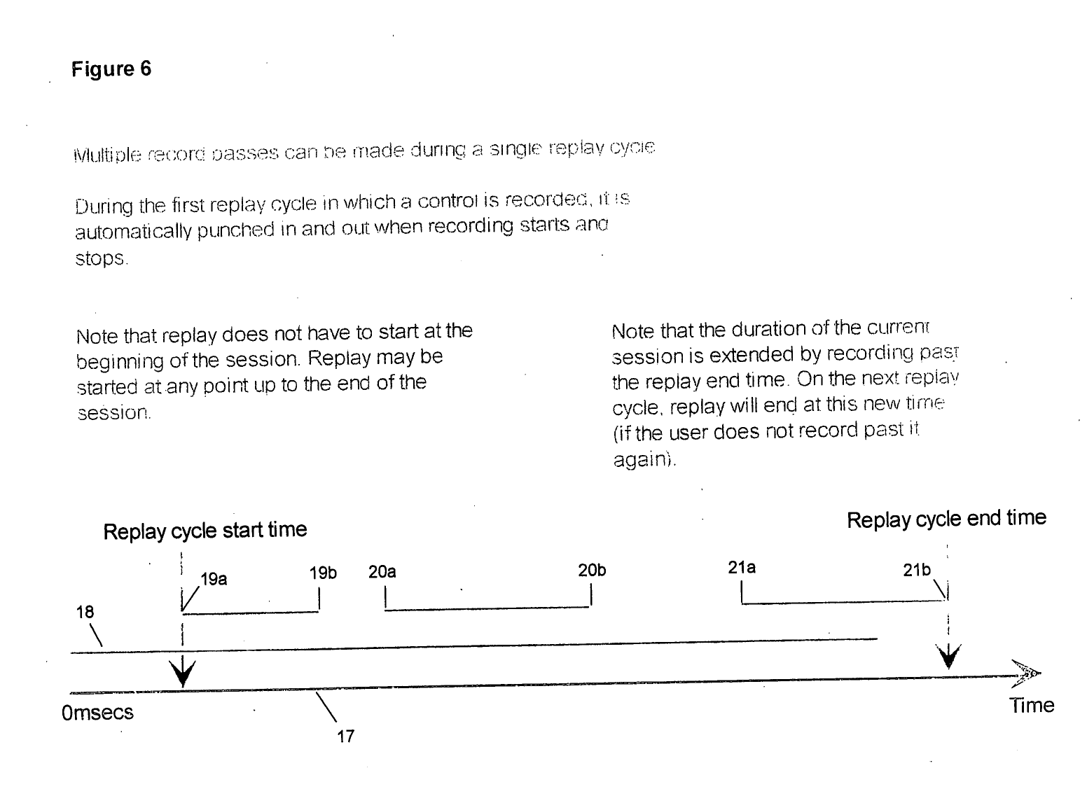

The replay cycle begins when the user starts playback. The replay cycle is terminated when either:
replay reaches the end of the session and recording is off
the user manually stops replay
replay has reached the end of the session and the user manually stops recording
   This is illustrated in FIG. 5: Replay Cycle.
   FIG. 6: Replay Cycle Flowchart.

This flowchart illustrates the various concepts surrounding the Replay Cycle. In FIG. 6, the horizontal gray line 17 denotes time. The blue line 18 is the current session, which represents the time extent of the current session. Superimposed above that are red lines which represent individual record passes. The magenta arrows illustrate where the Replay Cycle will begin from and where it will end. For example, if the user has placed the play cursor at five seconds, then the Replay Cycle start time is five seconds into the Drawmation session. Referring again to FIG. 6, the user would have pressed Play, then he/she would have turned on (hit) DM Record (record) a first time 19a, and then hit record again 19b to turn off Drawmation recording. Meanwhile, Drawmation play continues. The user would have hit record again 20a to punch in (start recording) and hit record again 20b to punch out (stop recording). Recording would stop, and play would continue. The third time the user hits record 21a, and during that pass, playback would stop because it would have reached the end of the current session and recording would continue until the user hit the record button again 21b, thereby both stopping the record pass and terminating the Replay Cycle.

As a convenience to the user, controls are automatically punched in and out, when recording is started and stopped, respectively, during the replay cycle in which they are first punched in. This enables the user to create the basic history for the control in the current session with just one replay cycle. This rough framework is refined and enhanced by the user on subsequent replay cycles.

If a user draws a red star on the screen and then turned on the DM Play switch (hits Play) and then hits Record, that star will be punched in. If the user follows the same sequences of punching in and out as shown in FIG. 6, then the user will end up with three Playbars or three portions of the session where the star was punched in and therefore is recorded to be visible for the times that equal the punch in times. On all subsequent replay cycles, the control will only be punched in if explicitly requested by the user. This is most commonly achieved by pressing the left mouse button while the mouse is hovering over the required control.

If a user left-clicks on the DM Rec switch (hits record), that will turn on Drawmation recording, but only if the user presses the left mouse button while hovering the mouse point over the control itself will Drawmation start to record additional data for that control, namely, to superimpose it on what's been previously recorded. This additional recording can add to what's been previously recorded or it can replace it. In the case of devices, it can modify the recorded operation of those devices.

A Record Pass

A record pass encapsulates everything that is recorded during a single start recording/stop recording cycle. There can be multiple record passes during a replay cycle.

A record pass is the sequence of operations that occur between the user enabling recording and disabling recording. This is most commonly seen by hitting the DM Rec switch once to turn on recording and subsequently pressing it again to turn recording off. FIG. 6 describes the sequence of events that occur at the point in time the user starts recording. FIG. 6 describes what happens in response to the DM Rec button being pressed (hit).

The first thing that happens after hitting record is that the software builds a list of objects not recorded on that replay pass. For example, if a user draws a red star then hits DM Rec, that is the control that would be added into this list.

FIG. 6 shows the software iterating through the list of objects, taking a snapshot of the state of each control in turn. These actions take place in response to the user turning on the DM Rec switch. Conceptually, these actions are all happening instantaneously. In practice this cannot be instantaneous, but all the Drawination data recorded at this-time has the same timestamp.

What the software does, is take the first object off the list, then it says, “have I recorded this before?” If it has, then it decides to take an update of that object.

At any given instant in time the star has a geometry, a color, a position and any other attributes Drawmation deems valid to record.

Turning on DM Rec doesn't record anything for an object until a user operates that object. That “operation” could be moving it, changing its color, rotating it, hiding it, or even deleting it. Drawmation obtains an update or create message for each object on the list. This happens when a user first presses the DM Rec button, even before a mouse is moved. This is all in an instant in time.

Back to the example just cited, Drawmation has previously recorded data for a red star and the User starts recording again. The user moves the star. On the down click, the current state of the object is saved in an update message. Subsequent moves are recorded in modify messages. On the mouse release, the final state of the object is recorded in another update message.

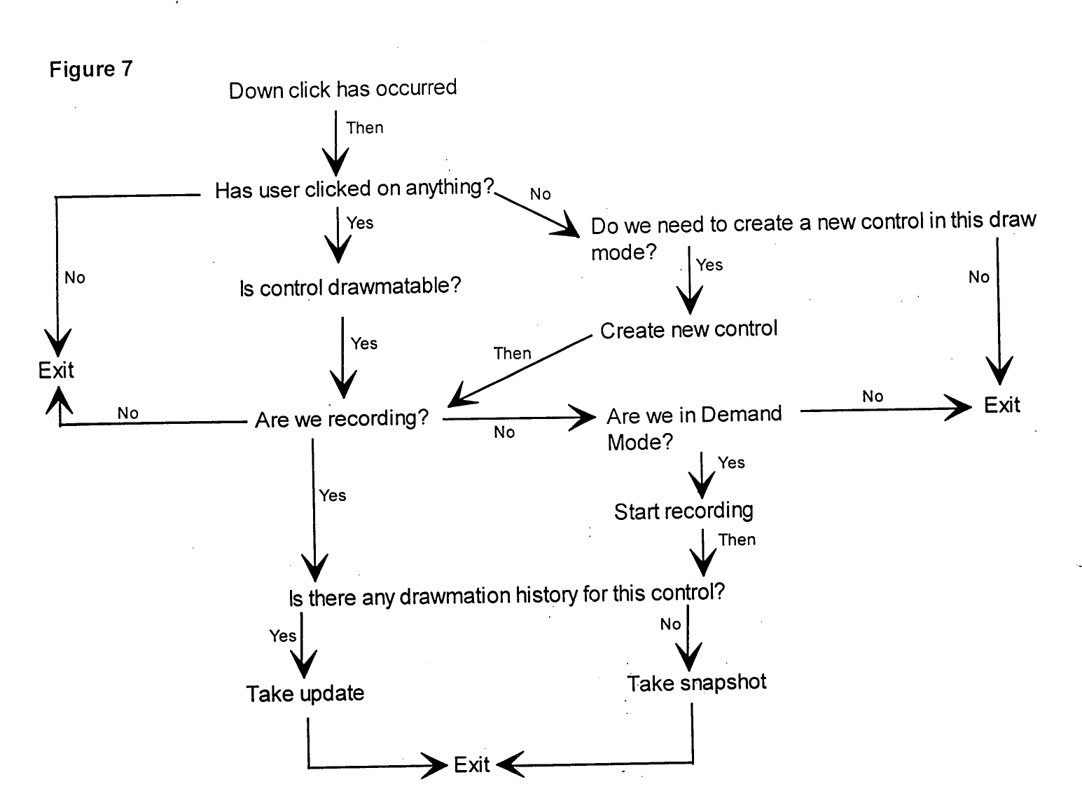

FIG. 7: Mouse Press flowchart

This is a flowchart for handling mouse presses on a control. The user down-clicks with a left mouse button and the GUI looks to see if that mouse position corresponds with anything. If it doesn't find anything underneath the mouse, it examines the Draw Mode or Text Mode to see if it needs to create a new object or not. If it doesn't need to create a new object, then there is no further action to take. If it does need to create a new object, then the GUI creates the new object and the creation of that object is recorded. If the user clicked on a real object, clicked on something that has previously been created, the software then tests to see if that object is currently enabled for Drawmation. If it's not, then again there is no further action to take as far as Drawmation is concerned.

If the object is enabled, then the software determines whether recording is occurring or not. If Drawmation is not recording then there is no further action to take from Drawmation's point of view. Except if the user has enabled Demand Mode, in which case, Drawmation is automatically going to start recording. Note: The record Demand Mode provides for a user to left-click on an object and have this automatically place Drawmation into active record for that object.

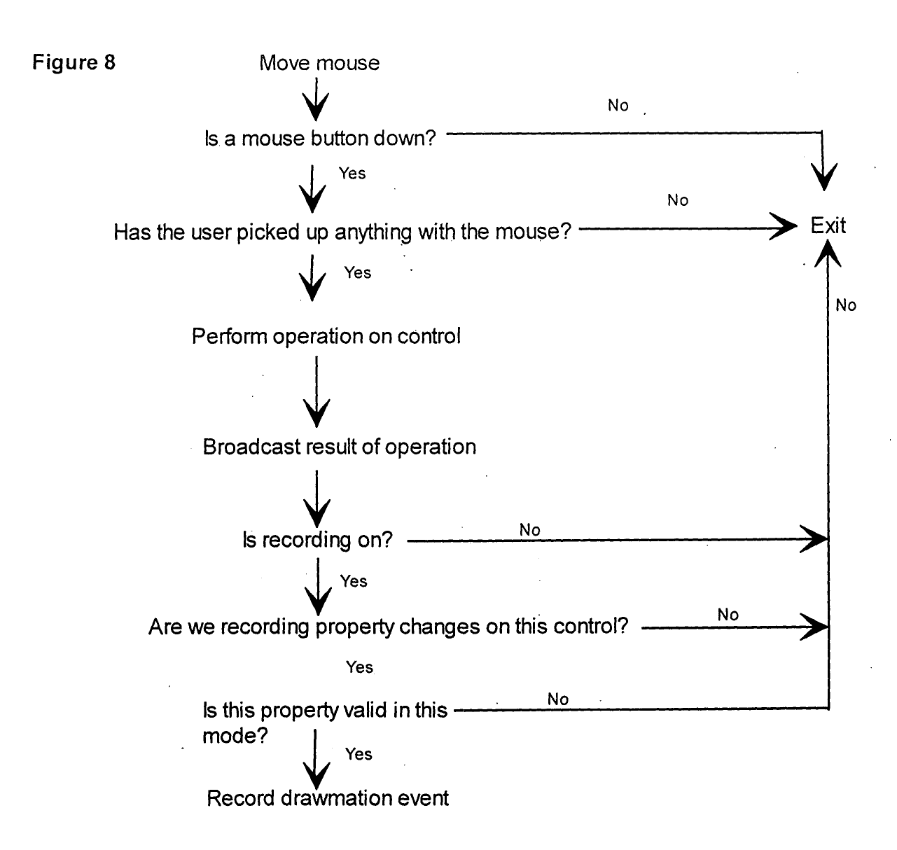

FIG. 8: Mouse Move flowchart.

If system receives a mouse move event from the operating system, Drawmation looks to see if there's a mouse button pressed. If there isn't, then it's got no further action to take. If there is a mouse button down, it looks to see if anything has been picked up with the mouse. If there hasn't, then there's no further action to take. If the user has picked up something with a mouse, then the mouse moves are applied to that control and the result is broadcast to Drawmation. Drawmation receives the event and says: “am I recording?” If it is not, it will discard the move. Otherwise, Drawmation looks to see if there is anything it needs to record. If there is, then that event is recorded and added to the history of the media for that control Note: In these figures, the words “object” and “control” are used interchangeably.

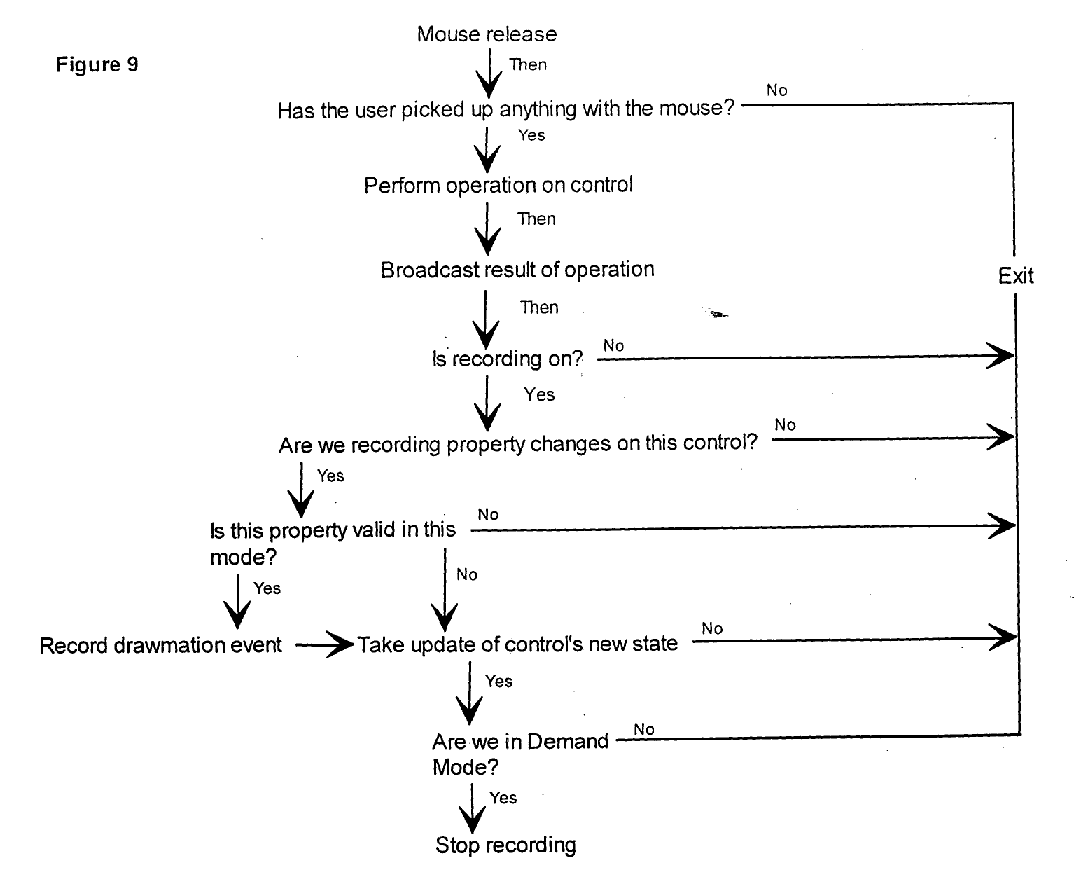

FIG. 9: Mouse Release flowchart.

On mouse release, a mouse release event is delivered to the system and the system looks to see if there's anything previously picked up with the mouse. If not, then there's no further action to take. If there is a control picked up with the mouse, then the operation is performed on the object and the result of the operation is broadcast to the contexts.

An example of an operation on a control would be the following: If a user clicks on a fader cap and then the user move the mouse down a distance of 10 pixels, the fader object will calculate what 10 pixels means in proportion to its overall height and calculate a value change. The value property change is broadcast to all contexts, using a modify message, that have registered an interest in that type of message.

If a context registers to receive message type with the Message Broker, in this case a modify message, then the Message Broker will deliver the message to all contexts that have registered to receive messages of that type. For example, the sound context and the record context are both interested in user adjustment to the value of a fader, so both register to receive modify messages with the Message Broker.

In Drawmation, when a message containing property information for a control is received, the context first tests to confirm that it is recording. If recording is enabled, Drawmation checks to see if it is recording property changes on this particular control and if the property type is currently valid for recording. Assuming all these conditions are met, the modify message is added to the Drawmation history for that control (written to the Media Layer).

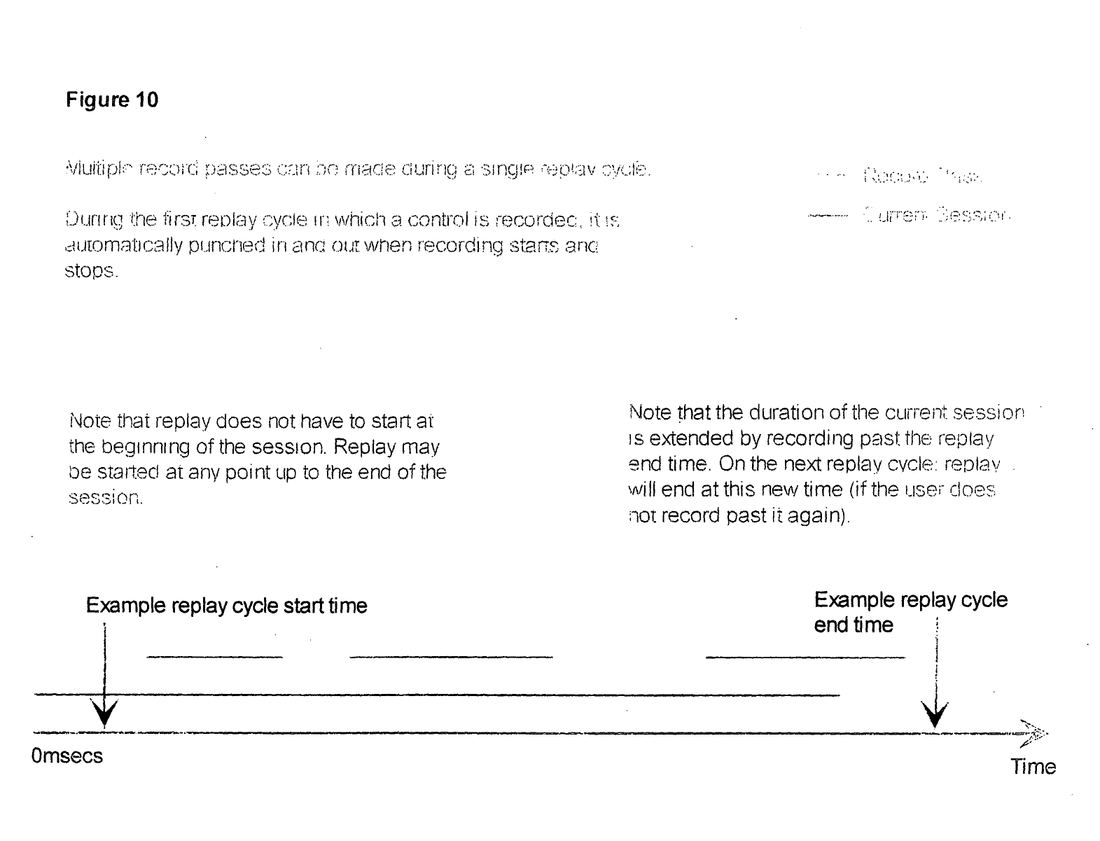

FIG. 10: Replay Diagram

At the beginning of replay the recorded controls are ‘reset’ to the correct state from which replay can continue. Those controls, which are punched out at the replay start time, are hidden, and those, which are punched in, are shown.

If replay is to start from the beginning of the session then everything is punched out.

If the replay start time is later than 0 milliseconds, a cache is used to record the state of controls at the replay start time in order to speed up the response time. Controls are reset from a single composite event in the cache, without the need to fast forward or rewind through their history. The event streams for separate controls are all reset to clear out any old data and then moved, without sending any information to the GUI, to the replay start time.

The replay cycle begins when the user hits the DM play button. The controls on the screen that are part of the current Drawmation session are reset to their original position at the time that replay is scheduled to start. At the end of the Drawmation session, they are left on screen in whatever state they've ended up. So, at the start of replay they must be reset so that the property changes that were applied to them throughout the session make sense.

If a user starts to replay from any time other than a few milliseconds from the very beginning, the Drawmation creates a cache of play information about each of the controls in the session which it uses to speed up its reset time. Also, at the beginning of replay, Drawmation resets all its event streams so that the accesses that the media at appropriate times for the replay start times . . . its position in the media to the replay start time. All of this is done, with GUI updates disabled so the user does not see the screen being shuffled.

Contexts have the facility to programmatically disable screen updates. So, Drawmation sends a message to the GUI saying: “don't do any subsequent screen updates until I tell you otherwise.” This enables Drawmation to move controls into different places on the screen, different sizes, different properties without the user seeing lots of activity on the screen which the user wouldn't understand. So when the updates are enabled, the display is already in the correct state for the beginning of replay.

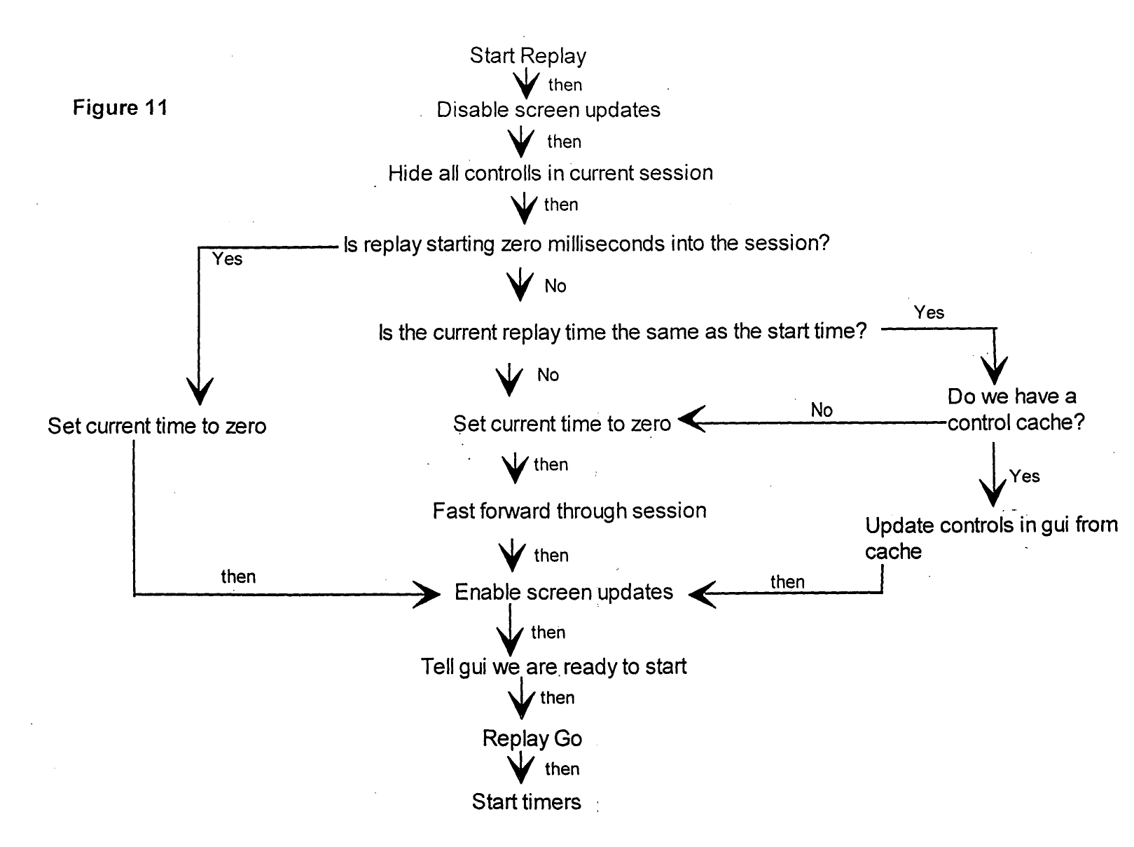

FIG. 11: start replay flowchart.

FIG. 11 describes a sequence of events that occur when the user hits the DM play button. First the software disables screen updates. Then it hides all controls that are in the current Drawmation session. The record context hides all the controls that are in the current Drawmation session. The Drawmation is then desiring to see what the replay start time for that session is.

When a user first hits DM Play, all of the controls that have been recorded by Drawmation disappear for a moment until Drawmation determines what should be on the screen and then it's all put back. The screen is refreshed to show all of the objects in a Drawmation in the proper starting location, ready for the Drawmation to be replayed.

Drawmation looks at the current session start time and asks: “is it starting from the very beginning?” If it is, then it needs to set the current time of replay to zero, re-enable screen update, and tell the GUI that the controls are all in the correct state for replay to commence.

Enable screen updates enable the display to be redrawn with all the objects in their correct place for the start of the Drawmation session. If Drawmation replay is selected to start from the beginning of the session, at time zero, then there is nothing to show because all controls are punched out at time zero. In this case there is no further action to take after the controls have been hidden.

Then there is a handshaking strategy whereby the record context tells the GUI that it has finished reconfiguring the screen and only after receiving this message does the GUI instructs Drawmation to start the replay timer. This enables the state of the Drawmated controls to be reset before replay starts, without having to account for the time the resetting process takes when calculating elapsed replay time.

The user can select a replay start time other than zero by placing the play cursor on the timeline. When the user does this, Drawmation adjusts the drawmated controls in the current session to correct state for the corresponding time in the session, using the cache.

Drawmation then requests an update, of all the drawmatable properties, for each control in the current session. Drawmation saves these update messages in a cache that corresponds to the start time selected by the user. When replay is restarted, if the current replay time is anything other than the start time selected by the user, Drawmation sends the update messages stored in the cache. This resets the controls to their correct state, ready for the start of replay. Drawmation repositions the Stream Layers, used for replay, to the replay start time, without needing to calculate any intermediate state changes.

If the User invalidates the cache by editing the current session, Drawmation recalculates the correct state for each control.

Once the GUI is in the correct state for replay to start, Drawmation enables screen updates again. This forces the GUI to be redrawn with all the drawmated controls in the correct state.

It creates the cache because it takes a finite period of time for the Event Layer to generate the necessary update messages that correctly set the state of each control for the replay start time. The time taken to reset the GUI is proportional to start time selected by the user. If the user selects a start time near the beginning of the Drawmation, there are fewer recorded property changes to take into account than if the user selects a start time nearer the end of the session. When Drawmation creates the cache, it is performing exactly the same process, but it is performed at a time when the user is not actually trying to play the Drawmation. Therefore the user is much less aware of the delay in moving controls to their correct state at this time.

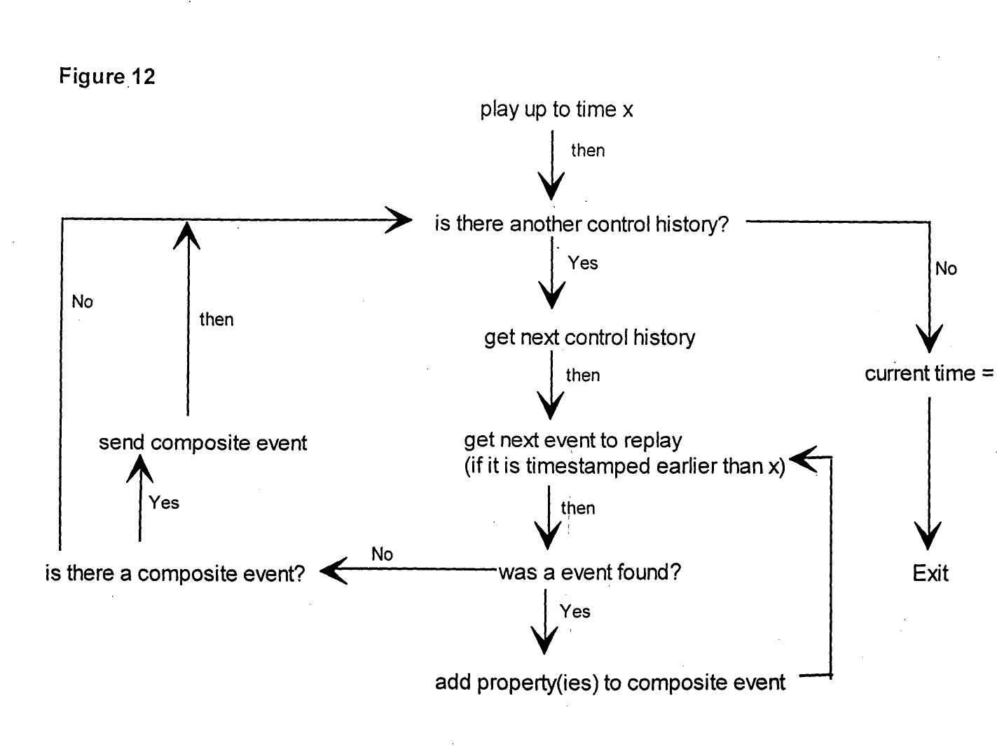

FIG. 12: normal replay flowchart.

During replay, Drawmation receives events from either the operating system or from the Sound Context. These events are used to calculate the time that has elapsed since replay was started. The elapsed time, together with the replay start time, specify the time the Drawmation session should be replayed to, for this event. So, when a user hits DM play, the start time is time zero plus wherever the play cursor was placed.

“Play up to time X” is the entry point to the flowchart. Drawmation replays messages from the current session up to and including those with a timestamp of X. “time T equals current replay time.” Time T represents the time the session was played up to on the last timer event.

Drawmation adds one millisecond to time T. A millisecond is added because Drawmation is able to record time information with a granularity of one millisecond. Drawmation uses a millisecond during normal replay as its time increment in order to preserve the order of events between controls.

The user can overlay multiple record passes on each media stream. Therefore it is possible to record property changes on different controls at the same time, with respect to the start of the Drawmation Session. These property changes may coincide with one another or at least occur within the same timer interval. In order to preserve the correct order of property changes on replay as on recording, Drawmation replays the property changes for each millisecond increment, replaying information for each drawmated control before moving onto the next millisecond increment.

If the current time is 30 milliseconds and the next time interval that Drawmation is told to play up to is 40 milliseconds, Drawmation plays back all the property changes that were recorded at 31 milliseconds, then 32 milliseconds, then 33 milliseconds, then 34 milliseconds, and so on, to 40 milliseconds. It does this on a per control basis. Drawmation selects the first control in the playlist, plays all the property changes for that control up to 31 milliseconds, then goes to the next control, plays all the property changes for that control up to 31 milliseconds. If Drawmation replayed all the events for the first control up to 40 milliseconds, it would be possible to replay a property change that was recorded at 39 milliseconds before a property change that was recorded at 31 milliseconds, on another control. The result would be that a property change was replayed out of sequence.

Each time Drawmation iterates round the loop, it retrieves all the property changes up to time T. Each property change retrieved that matches the test criteria is sent to the Message Broker. If the property change relates to a fader in the GUI, the value of that fader is updated and the fader is redrawn to show this new value.

The processing loop is terminated when Drawmation has iterated around the processing loop a sufficient number of times for time T to exceed the timer event time X. The current replay time is set to X. This completes the processing for the timer event.

At this point, the state of the GUI is correct for the time that was passed in with the timer event. If the sound context generated the timer event when it had replayed 30 milliseconds of audio data, then all the Drawmation data in the current session with a timestamp of thirty milliseconds or less up to 30 will have been delivered to the GUI.

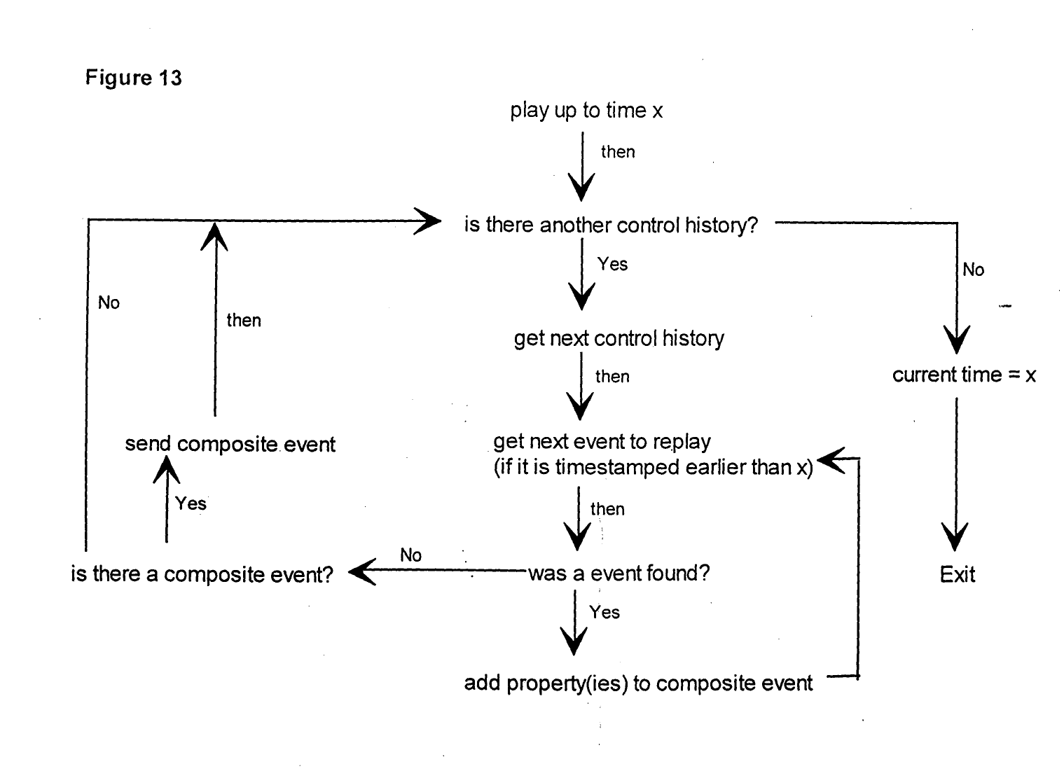

FIG. 13: Fast Forward Replay Flowchart

This is also referred to as self-adjusting replay. In fast forward, an update message is generated that sets the final state of the control at the end of a specified time interval. An update message is generated if property changes have been recorded that lie within the specified time interval (i.e., messages that have not been replayed during this replay cycle up to and including the specified time to play up to). Drawmation generates an update message for each control, if there are property changes to replay at this time.

Fast-forward is selected when the user clicks on the replay cursor with the mouse and drags it to the right (later in time), or Self-Adjusting is enabled from the Info Canvas of the DM Play switch.

Fast-Forward replay is considered self-adjusting because when using Fast-Forward, Drawmation attempts to send the minimum number of events that apply to the time interval as specified by the timer event. This minimizes the processing requirements of the system. Under conditions of heavy load, the demands placed on the processor may exceed that which it is capable of. This can arise if there was minimal system activity when the Drawmation Session was recorded and during replay there are other applications that require a share of the available processing bandwidth. Alternatively, the user may be replaying the Drawmation Session on a machine with less processing bandwidth than the machine on which the session was recorded. If the processor cannot keep up with the demands of Drawmation, the timer event is delayed until the processing from the previous event is completed and the resulting timeout period is longer than expected. The number of property changes to replay in this period is likely to be greater than in the interval that caused the processor overrun, in which case the processing demands are likely to be even more severe. In Fast-Forward mode, Drawmation sends only one event per control for each time interval no matter how long the requested interval. This gives the processor the greatest chance of ‘catching up’ with the requested replay rate.

Referring to FIG. 13, this flowchart is much simpler than the flowchart for normal replay. Again, Drawmation receives a timer event that specifies the time that Drawmation should play the current session up to. Drawmation then iterates through the controls in the session, constructing a single update message that represents the end result of all the events that were recorded for that time period, for the control. Drawmation then sends the update message event to the Message Broker (and ultimately the GUI).

“Is there another control history?” Once Drawmation has iterated through all controls in the current session, the current time is set to the time specified in the timer event.

Timer events are generated from a system interrupt (provided by the operating system) or from the Sound Context. The interrupt provided by the operating system is subject to delays due to processor load. The Sound Context obtains timing information directly from the sound hardware.

An example of “adding the properties to composite events” would be as follows. If in the time period 15 changes in position were recorded. All that is required is to send the last position that the control is moved to for this time period. There is no need to move the control through the individual changes when all that is required is to move the control to the position it should be at the end of the time period.

Then, “was an event found?, no”. Then, “is there a composite event?” In other words, has the Drawmation encountered any event during this interval? If it hasn't, there's nothing to send.

The update message is a single message that contains a number of property values. For example, in one message Drawmation can tell the GUI to change a control's color, value, and position. Any of the Drawmatable properties can be set in this single event. There is just one message to transport between Drawmation and the GUI.

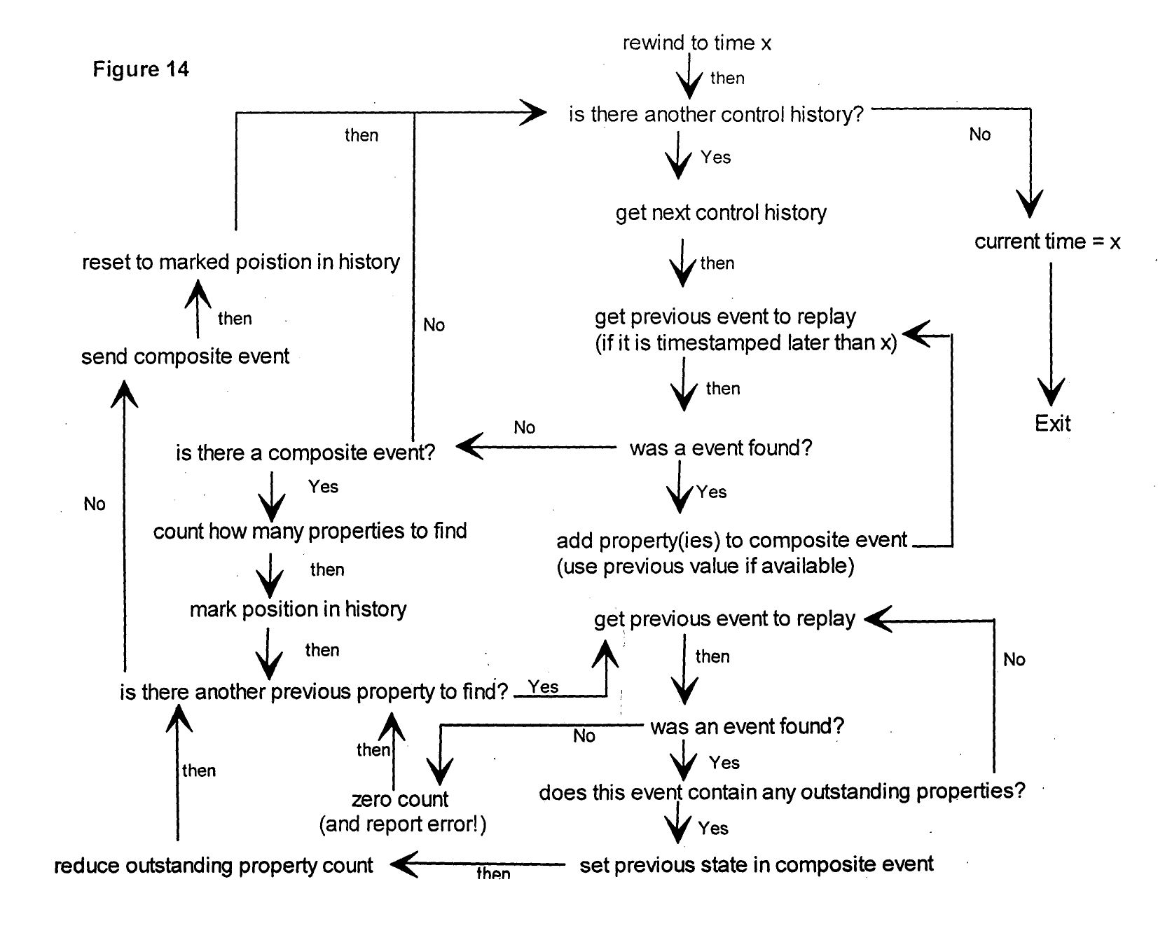

FIG. 14: Rewind Replay Flowchart

In rewind, it is the reverse of the recorded property change that must be replayed, in order to place the control into the state it was in before the user operated the control.

An update message is generated that specifies the previous state of any properties for which changes have been recorded. This is performed on a per-control basis.

Property changes are retrieved in reverse order, starting at the current time. First, an update message is constructed that identifies all the properties that were changed during the time interval. The previous state of those modified properties is determined by searching further back through the list to find the previous time that the property was set.

One optimization that is used for the most common property changes in response to mouse moves (as opposed to updates that are taken on mouse button clicks) is to record both the previous and the new property value so that when rewinding there is no need to search backwards though the list of events to find the previous property state.

Referring to FIG. 14, the user clicks down on the play cursor on a timeline or a play rectangle and drags the play cursor earlier. In response to each mouse event that this generates, the timeline or play rectangle calculates a time interval that this mouse movement represents and then subtracts that from the previous time that was shown on the timeline. This time is then sent to Drawmation which rewinds the current session to this new time. The flowchart describes that rewind mechanism. At the top of the flowchart you see the entry point where the time to rewind to is delivered to Drawmation.

“Is there another control history?” This is the entry point to the loop where Drawmation iterates through all the controls in the playlist. “Yes, there is another control for which we haven't processed this time interval for”. And then go on to get next control history. That control is selected from the list. “Get previous event to replay”. This retrieves the event from the media and compares it to the time it's rewinding to. If that time is later than the time it's rewinding to, this is a valid event to replay.

In the same way as when you play forward, events are read from the event history for that particular control, except this time Drawmation is working through the list backwards, towards the front rather than towards the end of the list.

“Was an event found that corresponds to this time interval?” If yes, then the property or properties that this event modifies is built into or added to a composite event which is exactly the same as the composite event that is used in fast forward. If a previous value is available in a modify message, then this value is placed into the composite event.

Drawmation then looks to see if there are any further events that apply to this particular time interval by looping back to the get previous event to replay stage. This loop is iterated around until there are no further events read from the media that fall into this time frame.

Drawmation then transitions to “is there a composite event?” If no events were found that apply to this time interval, then there will not have been a composite event constructed.

“Is there a composite event, yes. Count how many properties defined.” The Drawmation examines the composite event and determines how many properties it needs to determine what the previous values were for—in order to put the control into the state it was before these events occurred during recording. It then marks the position in the history. Drawmation remembers where it was in the history for this control so it can revert to this position—once it has searched earlier in the list to find previous values. It then examines the count to see how many properties it needs to find. And then we test “is there another previous property to refind to queue the start of our loop for searching backwards in the list.”

“Is there another previous property to find, yes”. Then, “get previous event to replay.” The next event earlier in the history of this control is read from the media and examined. “Was an event found?” Drawmation looks to see what type of message was recorded for the control. “If yes, does this event contain any outstanding properties?” Did the property change of that event we just read correspond to any of the properties that we're trying to find when searching backwards through the list. Yes is the downwards path. So we overwrite set previous state in composite event, and we update the composite event with this value we have just read from the history. We then move across to “Reduce outstanding property count.” That decrements the count accordingly depending on how many events were in the event message we read from the media and then we move back to the start of the loop where we test “is there another previous property to find?”

Play Cursor Movement

The user can manually move through the Drawmation by placing or dragging the timeline cursor.

Blackspace provides a navigational tool for navigating around Drawmation. This is called a timeline. A timeline can either be presented as a linear timeline or as a play rectangle. This timeline shows the time relative to the Drawmation session and shows a play cursor which indicates the current point in the Drawmation session that we have reached. The user can click the mouse on the play cursor and either move the play cursor earlier, therefore rewinding through the Drawmation, move the play cursor later, therefore fast forwarding through the Drawmation, or click on an entirely different place on the timeline, thereby jumping directly to that time in the Drawmation. When the user places the play cursor, the Drawmation moves in a single step to the new time, either going forwards or backwards. When the user drags the play cursor, the Drawmation moves to the new time in incremental steps based on the speed of the mouse movement as translated by the timeline into time intervals.

The way that the system is self-adjusting in this case is that the faster you move, the faster the user drags the mouse, the greater distance is moved between each mouse event as delivered by the operating system. Distance is directly translated to time by the timeline. Time is proportional to distance.

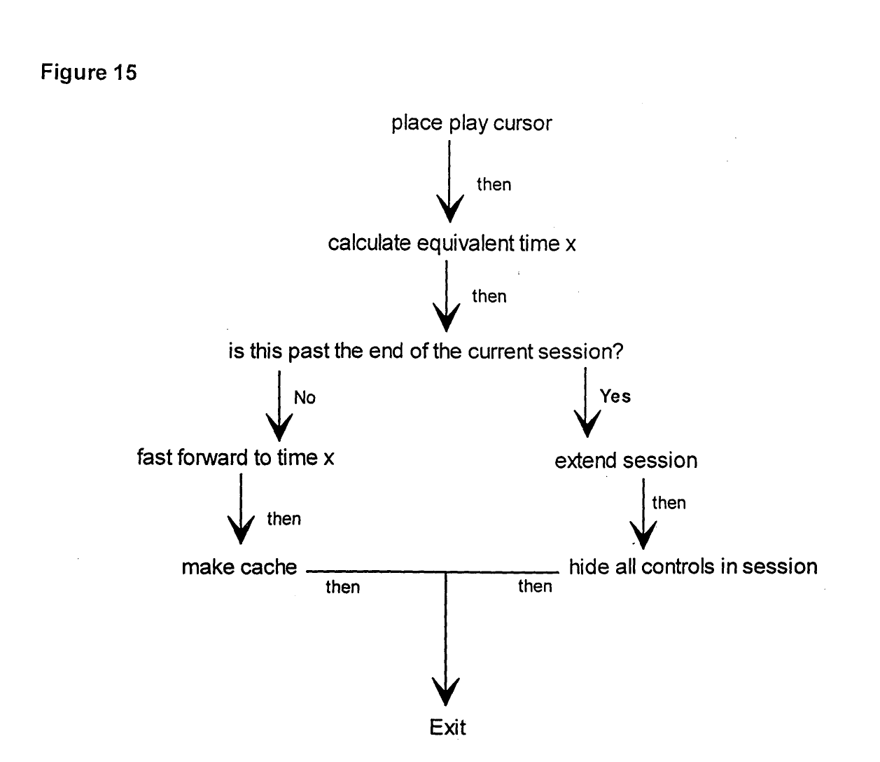

FIG. 15: Placing the Cursor Flowchart

When the user places the play cursor, the Drawmation jumps to the new time, using fast forward or rewind replay.

The replay start time is set to the time specified by the cursor.

See “place play cursor flowchart”.

The state of all controls in the Drawmation is taken and placed in a cache for use at the start of replay.

FIG. 15: “Place play cursor.” This is the action of the user clicking on the timeline away from the current play cursor position. “Calculate equivalent time X.” The timeline determines what the new time for the session should be and passes this to Drawmation. “Is this past the end of the current session?” Drawmation examines the time and compares this to the current session information. If this time is later, it takes the “yes” branch, and then expands the session to match the new time that the user placed the play cursor down for. Since the user has moved the time on the timeline past the end of the current session, all controls must be punched out at this time. Therefore, Drawmation needs to hide all the controls in the session and then exit the flowchart. “Is this past the end of the current session?”—No. Drawmation fast forwards to the new time, and then makes a cache. Drawmation takes a snapshot of the state of all the controls in the Drawmation and saves this for future use when going back to the start of replay. This terminates the other branch of the flowchart.

When the user clicks the mouse on the timeline or play rectangle away from where the current play cursor is, the timeline moves the play cursor to this new position and calculates what time this is equivalent to based on its current scaling.

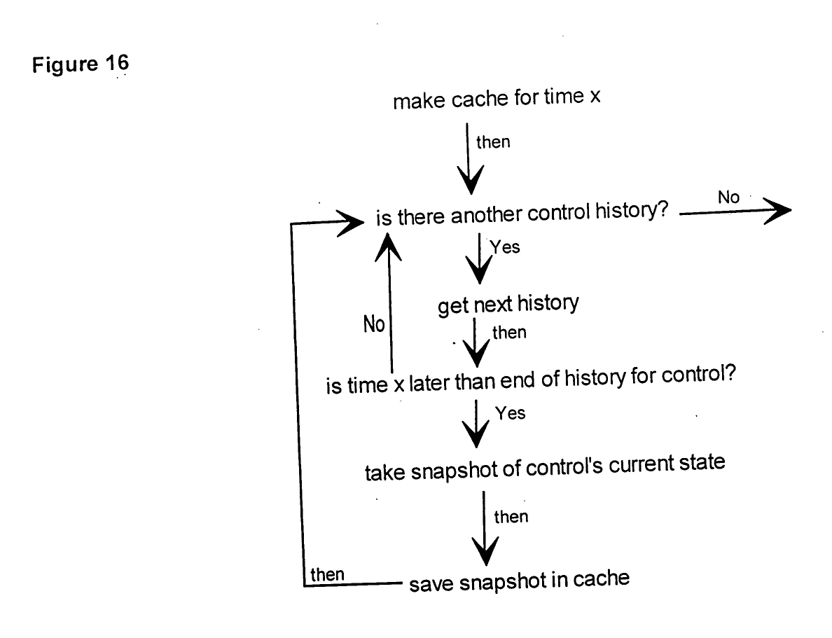

FIG. 16: Make cache flowchart

Dragging the Cursor

When the user drags the play cursor to a new position, the Drawmation is played (forwards or backwards) to match the new time. If the user drags the mouse very quickly then the change in mouse position will be relatively large between mouse events (from the operating system), and if the mouse is dragged slowly, the change in mouse position will be small. Each change in position represents a time interval on the timeline. The Drawmation is played or rewound to the new time using composite events for each control, one per time interval.

Dragging the Cursor. The user can downclick with the left mouse button hovering over the green play cursor on the timeline and then drag the play cursor to either earlier up until the start of the session or later past the end of the session. Drawmation will either replay or rewind to keep pace with the user's interactions by the mouse. Effectively, the user is scrubbing backwards and forwards through the Drawmation session. The user's movements are translated into time events based on the distance between mouse events. The distance between mouse events is directly proportional to time. The faster the user drags the mouse, the greater the distance between mouse events; therefore, the bigger the steps in the Drawmation session.

Playbars

Playbars are used to provide a graphical representation of the recorded history of property changes on a control.

Playbars reflect when the control is punched in. While a control is punched in, transactions can be recorded. Transactions are only recorded while the control is punched in.

Playbars are a graphical representation of the control history in a Drawmation session. They are used for two purposes: firstly, they show when the control is punched in and punched out; and secondly, they show the individual transactions that have been recorded on a control whilst recording was enabled. Playbars show transactions rather than individual events in order not to swamp the user with information and provide the information to the user in a manageable form.

The transaction is all that is involved from the down-click of the mouse button to the upclick of the mouse button. It may involve a mouse drag during the transaction.

A transaction is different from an event in this regard. Events occur with a one-to-one relationship between mouse moves and mouse operations or keyboard entry. Transactions are started on a mouse down-click and are terminated on a mouse upclick.

If the user down-clicks on a fader cap that begins the transaction. The user continues to hold the mouse button down and drags the fader cap up and down. This causes movement of value change events to be delivered to Drawmation as part of the same transaction. Upon the user releasing the mouse button, the transaction is terminated.

The playbars show transactions to the user in order to provide the information in a manageable format. The playbars summarize the Drawmation history so that it is easily manipulated by the user and the user can relate the transaction to the interactions that the user has made. The user does not think in terms of individual mouse events. The user thinks in terms of down-clicks and moves. Playbars are showing the transactions and the GUI is receiving all the events.

Punch In and Punch Out

During the replay of graphical properties, a control is visible when it is punched in. In the general case, a mouse press on a control during recording of Drawmation punches that control in (if recording is enabled on that control) and the mouse release punches the control out.

During the replay cycle in which history is recorded for a control, the control is automatically punched in during each record pass.

A control can only be recorded when it is punched in. Punch in is reflected on the playbar by the presence of the playbar. If there is no playbar visible at the current event in time, then the control is not visible and is punched out.

Transactions

Playbars are also used to represent the operations on a control. For example, a single Playbar could represent a single continuous movement of a control. If there was a long pause during the movement, then the system would automatically split the movement into three separate sections (move, pause, move) and show each as a separate Playbar.

Playbars represent transactions in order to give the user a coarse representation of the events recorded by Drawmation. Under normal circumstances, playbars show where the user down-clicked, and where the user up-clicked. As an additional convenience, if the user pauses during a movement for more than one second, the Drawmation interprets that as a pause and creates a separate transaction for the pause, effectively splitting the movement into two separate playbars. If the user punches the control in, then down-clicks to begin a movement, does a move, pauses for a second, does another move, up-clicks, and punches out by stopping recording, you will see five playbars. The first playbar is the static portion at the beginning of the recording when the control was punched in but not moving. The second playbar is the first period of movement. The third playbar is the static period of movement during—the static period representing the pause. And the fourth playbar is the second period of movement. The fifth playbar is the static period after the user has released the mouse before the control was punched out by stopping recording.

Editing

Drawmations are edited using a combination of the following tools:
recording over old previously recorded events
adjustment of Playbars using the timeline
menu commands for specific functions
Overwriting
Playbar Adjustment

Let's use the previous example. There are five playbars and a user moves one of them. Let's say the user moves one of the motion playbars that represents moving the object. What is going on in the software to account for the fact that the playbar is being moved and it automatically edits the action?

Drawmation enables or allows the user to edit the Drawmation session by providing playbars on the timeline. When the user grabs or clicks down on a playbar and adjusts it using the mouse, the Drawmation applies a set of rules to control how that Drawmation is edited. These rules are implemented by the timeline so that the user sees what will result from the edit before the user release the mouse. When the user release the mouse, the edit is connected to Drawmation and Drawmation replicates was shown on the timeline. There are a number of modes that can be used here: there's static, shuffle, static shuffle, stretch, stretch shuffle and shuffle all. In static mode, the playbar events within a playbar are not adjusted. In stretch mode, all the events within a playbar are preserved.

So, if the user shortens or extends the playbar, the timing of the events within that playbar are extended and contracted proportionately. For example, if the user statically shortens a movement playbar, the movement will be truncated because the user has punched out the control at the point where the static playbar—and if the stretch mode was on when the user adjusted a movement playbar by dragging either of the endpoints, no data would be lost because the movements would either be compressed or expanded to match the required segment length. If the user contracts or extends a playbar to introduce a gap that is visible on the timeline, the Drawmation automatically punches out the control for that period of time, as represented by the gap between the playbars. The rules that Drawmation follows are exactly the same as those for timelines for playbar adjustment.

The additional work that Drawmation does is to insert or punch out the control when gaps open up in the playbars. In addition, when shuffle all is selected, Drawmation performs the shuffle operation on all controls in the playlist, not just those currently selected for viewing on the timeline.

The user has three means of editing Drawmation history. The user can record over the top of something that has been previously recorded. The user can adjust playbars to change relationships between the history of individual controls and there are a number of specific functions that can be invoked from menu options in the Info Canvasses of individual controls.

Set DM Geometry

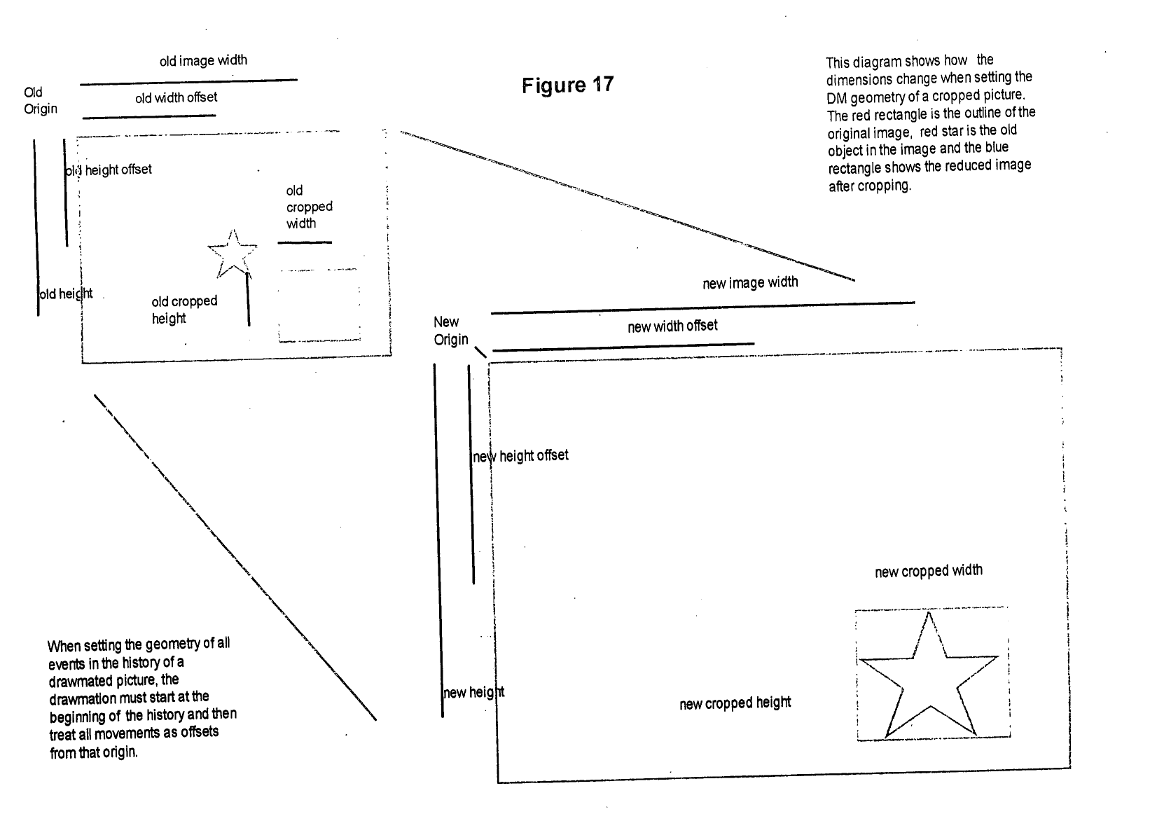

FIG. 17 illustrates the changes in dimension that occur and the dimensions that must be accounted for when using the “Set DM Geometry” option in Info Canvas for graphic control when editing the previously recorded movements on those controls. In the example shown, we are using the image of a red star which has been cropped from an original picture that had a large black background surrounding the star.

The red star image has been cropped to the image represented by the blue square surrounding the red star. The important dimensions—or the most important dimension—is the top left corner of the red rectangle which represents the old origin of the picture. Any subsequent images in the Drawmation that relates to this red star all use this same origin, whatever the position of the red star in the individual pictures. Drawmation maintains this original position when replaying images in order to keep the replay consistent with what the user would see if the entire—the full size images—were replayed.

When accessing the DM geometry, it is possible to rescale the images and reposition the images within a Drawmation. When testing with the DM geometry, the user is specifying the new origin and the new scale as if the full size images had been adjusted. The dimensions shown of the red rectangle in the bottom right of FIG. 17 demonstrate the changes in the dimensions which Drawmation must account for when adjusting the recorded information. It's important to note that not only is the size of the cropped image scaled, the offset to the adjusted origin are also scaled. On replay, the Drawmation replays the individual images as if the full size images had been recorded at this scale. There is additionally a slightly simpler option to the user wherein instead of scaling, the user just sets the origin of the images to use which allows the user to create an animation and reposition that animation with respect to other information recorded in the Drawmation session.

Set DM Origin

Set DM origin is achieved by the user positioning the control at any point in the Drawmation session. So it's not replaying. So by dragging the play cursor or placing the play cursor to make the image visible on the screen and then dragging the control—it doesn't necessarily have to be an image—any of the controls that are recorded by Drawmation can be used with this option—to the required location, what the user is doing, is the user is specifying the position at the beginning of the Drawmation that that control will use. So, not only is it the origin in terms of XY coordinates, it is always the starting point for the Drawmation history for that control. So, all subsequent movements will be based on the control being in that position when Drawmation begins. Drawmation iterates through all the recorded history for that control and it calculates the displacement required—or the delta it needs to apply—to each positional property change with respect to the difference between the old origin in Drawmation and the new origin. So, all movements appear to start from the new position when the Drawmation is replayed.

Looping play bar segments in a Drawmation session.

Every Drawmated object (an object that has been recorded in Drawmation) can have one or more play bar segments that belong to it appear along one or more linear time lines and/or one or more Play Rectangle timelines (PR).

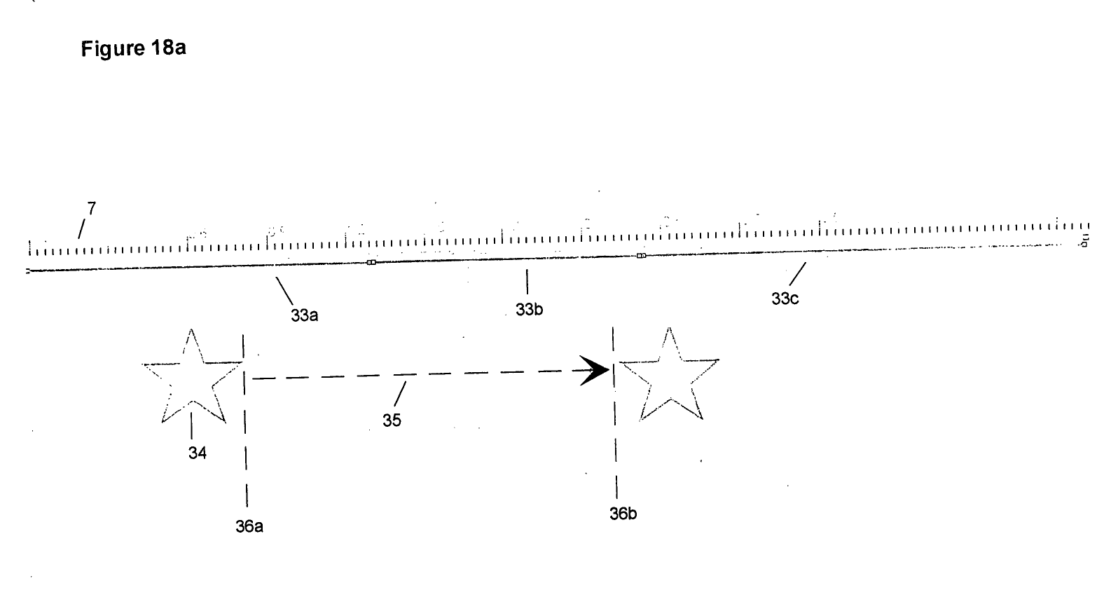

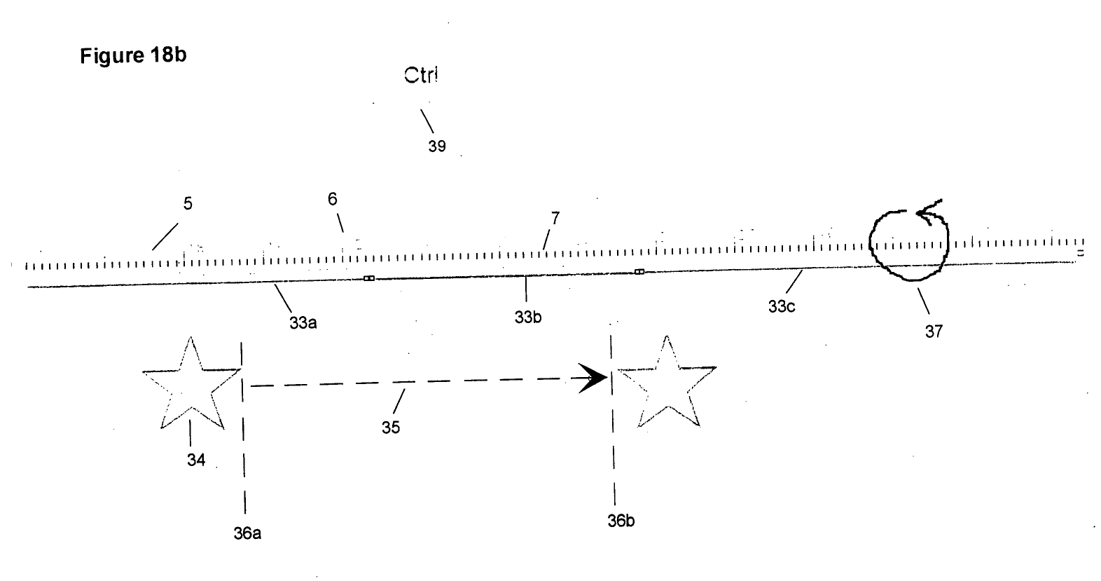

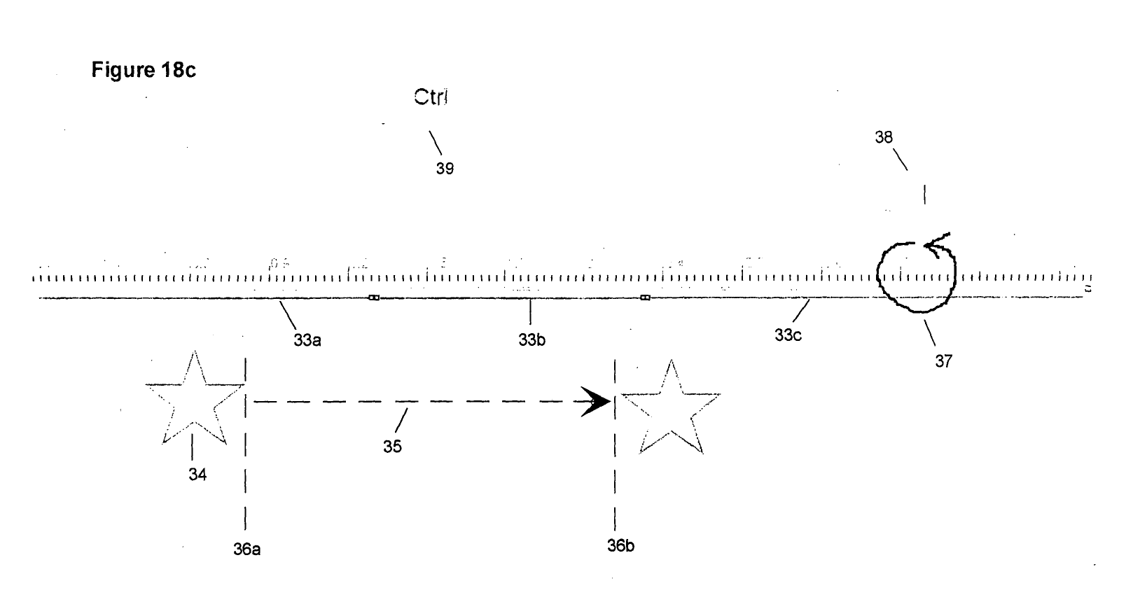

FIG. 18a illustrates three play bar segments for a Drawmated star. Play bars are a graphic representation of the information that Drawmation holds about an object. This information is divided up into segments, each segment representing some particular condition in Drawmation for that object.

FIG. 18a shows a blue star that appears onscreen and is then dragged to the right a certain distance where it remains for some period of time. The first play bar segment for this star starts when the star first appears and ends when the star starts moving. This section (segment) of the playbar is described as “static.” The object is shown and is visible but is not moving.

The second segment shows the time that the object commences moving until the time it stops moving. This is referred to a moving or moved segment. The third segment, which is again a static segment, commences when the object stops moving and extends until the time it disappears from onscreen or until the end of the Drawmation.

Referring to FIG. 18b, the Control Key (Ctrl) 39 is held down and the first 33a and third 33c segments of the blue star are left-clicked on to select them. Then a recognizable graphic object 37, which is called a loop, is drawn such that it intersects the timeline.

Referring to FIG. 18c, after the software recognizes the loop 37, a switch 38 appears adjacent to the loop. On this switch is a text cursor. The user then types a number on this switch that equals the number of loops that are to be performed. Let's say the number 10 is typed on this switch. Then when the switch is touched, the software will build ten loops that start from the first selected play bar segment 33a and end with the third selected play bar segment 33c. This will be repeated 10 times. Then when the DM Play switch is turned on,'t his loop will cause the blue star to move across the screen and then move back across the screen 10 more times. At then end of the last loop, the Drawmation will continue to play in its normal fashion.

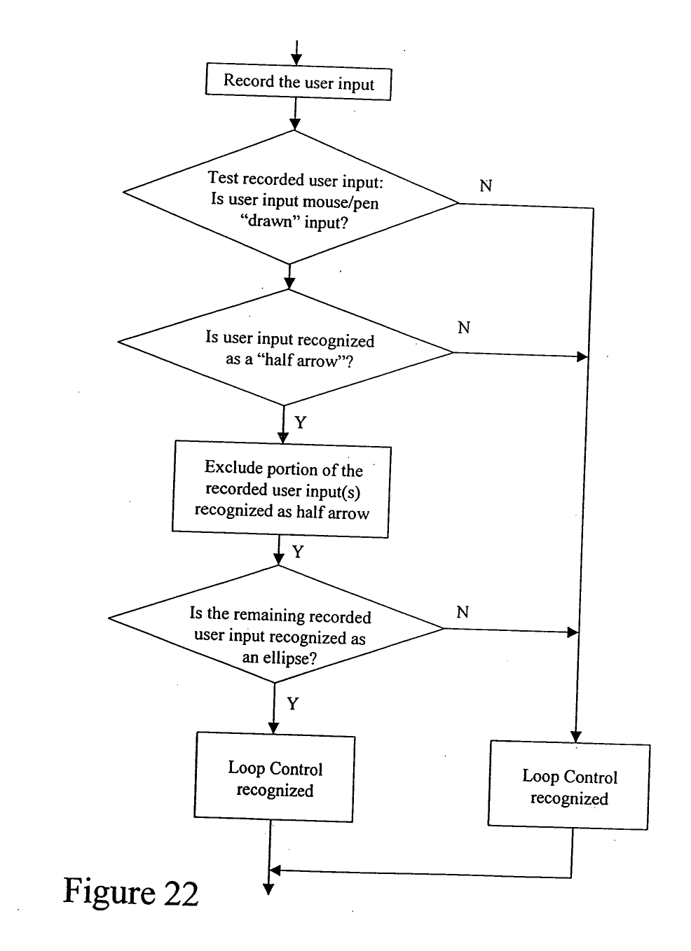

The process of recognizing a drawn loop as a loop control is now described with reference to the flowchart of FIG. 22. The process begins by recording the user input. Next, the recorded user input is tested to determine whether the user input is a mouse/pen “drawn” input. If no, then loop control is not recognized. If yes, then a determination is made whether the user input is recognized as a “half arrow”, i.e., a line drawn with half of an arrow head. If no, then again loop control is not recognized. If yes, then portion of the recorded user input(s) that is recognized as a half of an arrow head is excluded.

Next, a determination is made whether the remaining recorded user input is recognized as an ellipse. If no, then loop control is not recognized. If yes, then loop control is recognized.

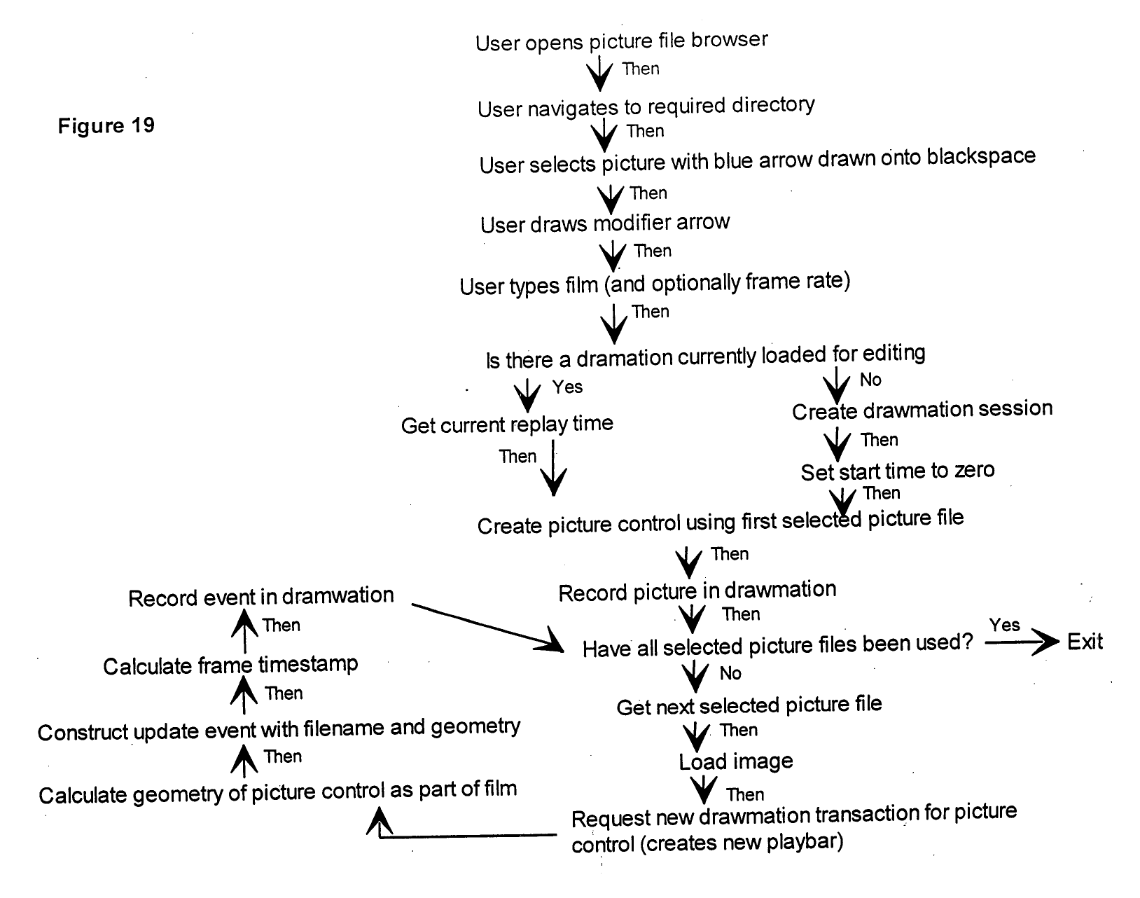

FIG. 19: Using the blue “sequence” arrowlogic to create a film from a collection of images.

The first set from the flowchart indicates what the user would do in order to invoke this operation. Starting at the top, user opens picture file browser. The user types P on the screen and then hits escape and that brings up the picture file browser. The user navigates to the directory which contains the pictures the user wants to crop. The user selects the color blue in an inkwell and turns on the arrow mode and then draws an arrow from the folder to Blackspace. When this arrow is recognized by the software, its arrowhead will turn white. The user then draws a modifier arrow from Blackspace across the shaft of the first arrow ending in Blackspace. As an alternate, this arrow can intersect the first arrow's shaft or the tip of this second arrow can point to the first arrow's shaft or this second arrow's shaft can originate from the first arrow's shaft.

When the modifier arrow is drawn and recognized by the software, two things happen: a text cursor automatically appears at the tip of the modifier arrow and the tip of the modifier arrow turns white. The user then types “film” as a modifier at the tip of the second arrow where the text cursor has appeared. The user may also specify a frame rate at this point. Otherwise a default frame rate of 15 frames a second is used. To specify a frame rate, the user could type “film, 30”. This would mean create a film that has a rate of 30 frames per second.

When the user clicks on the white arrow head of either arrow, control is passed to Drawmation and the remainder of the flowchart illustrates the process that Drawmation follows. Is there a Drawmation currently loaded for editing? If the film is to be added to existing Drawmation, there is no need to create a session. What Drawmation does if it takes the yes branch is to get current replay times so Drawmation determines where the play cursor is currently positioned and inserts the film into existing Drawmation at that point in time. If it takes the no branch, a new session is created and a start time for the film is set to zero because there's no other data to correspond to. Create picture control using search selected picture file takes the first file name as specified in the list of pictures selected by the user with the arrow and creates a picture control using this file name for the image in which the picture control is going to show. This picture control is then recorded as the first event of the control history for the picture in Drawmation.

We then enter the main processing loop which deals with the remaining pictures selected by the user. Have all selected picture files been used? This tests to see if there are any remaining files in the list selected by the user which have not been included in Drawmation. If the answer to this is no, Drawmation gets the next selected picture file, and it loads the image of this picture file, although this is not displayed to the user. Drawmation requests a new transaction for the picture control, which forces a new play bar to be created to represent the new image.

“New Drawmation transaction” means that when you show the completed film on a timeline, you get a play bar for each frame. Each play bar represents a transaction. A play bar for each picture is represented along the timeline in a single playbar row. Drawmation pretends that the user down-clicks, selects a picture to be inserted into the frame at that point, and then up-clicks to create a new transaction in Drawmation. Using the loaded image, Drawmation calculates the geometry of the picture control as it would appear in the film. Drawmation constructs an update message with a file name and geometry. These include the file name, picture to display, and the geometry of the picture which specifies its width, height and top left coordinates. Calculate frame time stamp determines when this frame should appear relative to the start of the film, recorded in Drawmation, the composite event is stored and added to the control history for that control and Drawmation goes around to the beginning of the loop again to “have all selected picture files been used?”. After going through this loop processing all the files in the list, the end result is a yes and the film has been created in Drawmation.

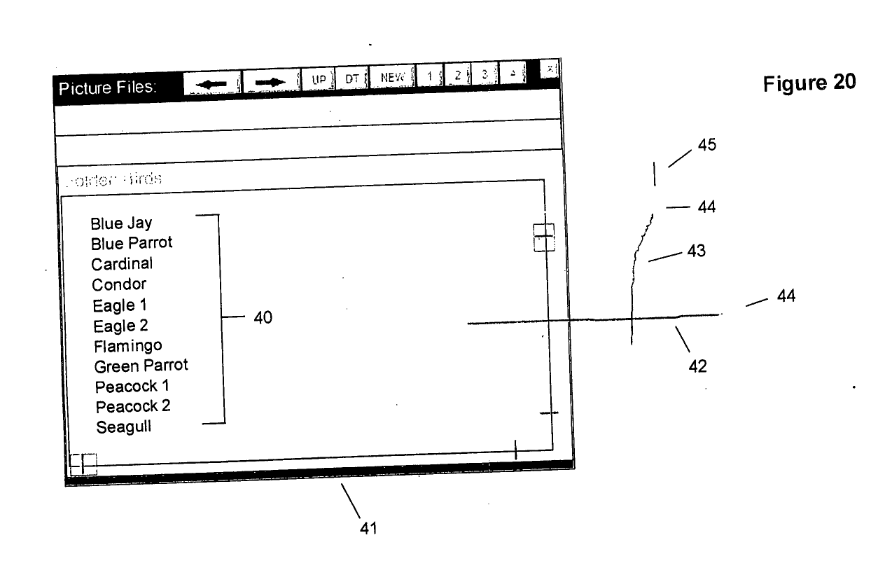

FIG. 20 illustrates the creation of a film using the blue “sequence” arrow.

After typing a P in Blackspace the Picture Files VDACC 41 appears. The user navigates to the list of images 40 that the user desires to create a film with. The user then draw a first arrow 42 that either intersects the Picture Files VDACC or starts within a default gap of the VDACC (usually ¼^{th} inch). When the tip of the first arrow turns white 44, a second arrow 43 is immediately drawn. When this arrow is recognized by the software two things happen: (1) the tip of its arrowhead turns white 44, and (2) a text cursor 45 appears adjacent to the white arrowhead.

When the user left-clicks on either white arrowhead, the film is created. This means that each image in the list intersected by the blue arrow is played in sequence at a default frame rate or at the frame rate determined by the user.

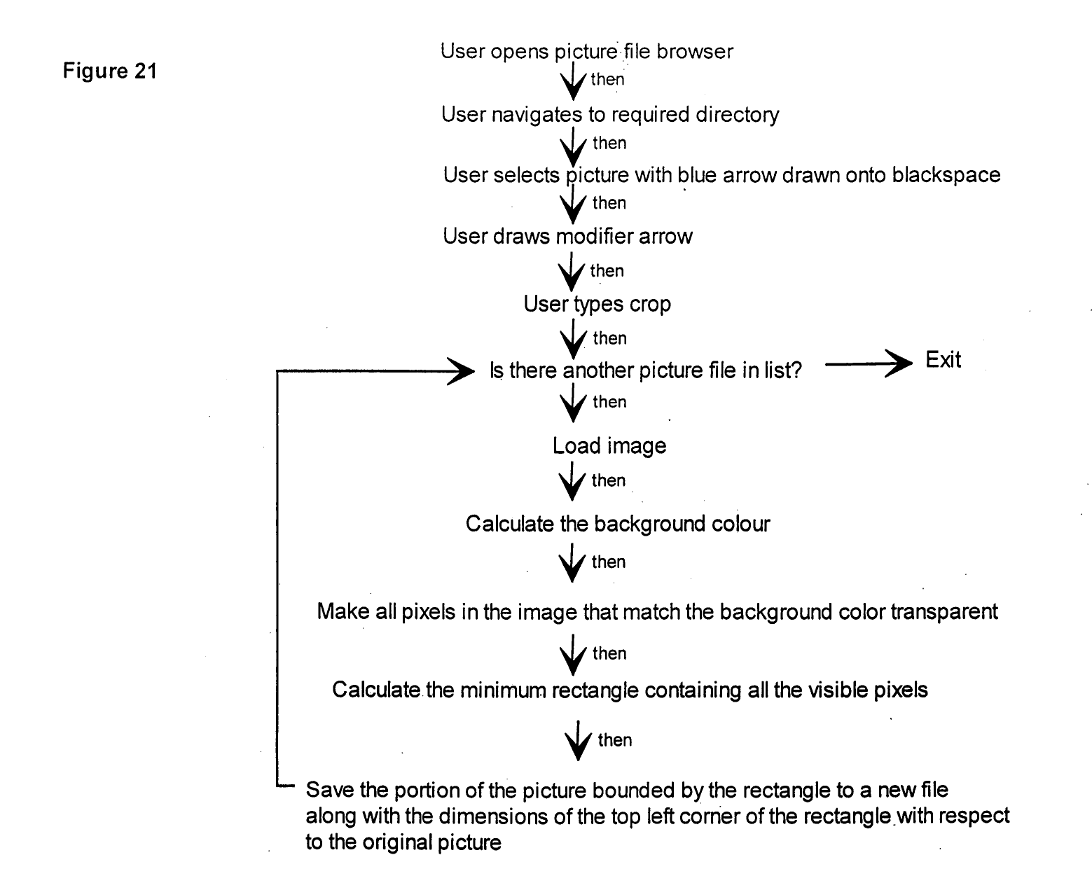

FIG. 21: Cropping images with the drawing of a blue (sequence) arrow.

The first steps in the flowchart indicate the actions the user performs in order to invoke this operation, and the remaining steps indicate the processing that Drawmation follows in order to implement this on behalf of the user. So the user opens picture file browser by typing P and then escape in black space. The user navigates to the required directory containing the pictures the user wishes to crop. The user selects the pictures the user wishes to crop by drawing a blue arrow from the directory onto black space. The user then draws a modifier arrow which starts from black space, intersects the shaft of the first arrow and ends in black space.

The user types “crop” on the modifier and hits the white arrowhead. At this point, control is handed over to Drawmation. Is there another picture file in the list? This is the entry point to the loop that Drawmation follows in order to process each file in the list as provided by the user. Load image. Drawmation loads the first image for the first file in the list. Calculate the background color. Drawmation determines what the background color is by examining all four corners of the image. Drawmation then makes all pixels in the image that match the background color transparent. It does this by creating an alpha mask that matches those pixels in the image with the background color. Calculate the minimum rectangle containing all visible pixels. Drawmation then examines the resultant image to see what is the smallest rectangle that found all the pixels that have non-transparent data. Drawmation saves the portion of the picture bounded by the rectangle to a new file along with the dimensions of the top left corner with respect to the original picture. Drawmation extracts just the portion of the image bounded by the minimum rectangle and saves it to a separate file with a new file name that allows the image to be uniquely identified. The flowchart then transitions back to “Is there another picture in the file list?” Drawmation iterates through the file list until there are no more files and then exits.

When the software crops an image, the file name that is used is the original file name with the x and y dimensions of the cropping added to the file name. These dimensions are the delta between the new top left corner of the image and the original top left corner of the image. However, the original file name with the x and y dimensions of the cropping may be saved internally in the image rather than in the file name.

Summary statement: Blackspace uses principles of having lines represent time spans in an environment that is controlling a general graphic environment. All media can be represented by the same type graphical playbars and the editing of these playbars is the same for audio, video, Drawmation, etc. Any graphical object can be represented by playbars.

The invention described herein can be implemented in any combination of software, hardware and/or firmware. An embodiment of the invention includes a storage medium, readable by a computer, tangibly embodying a program of instructions executable by the computer to perform method steps for recording and replaying property changes on graphic elements in a computer environment, as described herein.

Although embodiments of the invention have been described and illustrated, the invention is not to be limited to the specific forms or arrangements of parts so described and illustrated. The scope of the invention is to be defined by the claims appended hereto and their equivalents.

1. A method for recording and replaying property changes of graphic elements in a computer environment comprising:
recording graphical and functional information of said graphic elements as properties of said graphic elements are changed; and
replaying at least a portion of recorded changes pertaining to said properties of said graphic elements using said graphical and functional information.

2. The method of claim 1 wherein said recording includes extracting said graphical and functional information of said graphic elements from broadcast messages and saving said graphical and functional information as recording data.

3. The method of claim 2 wherein said graphical and functional information corresponds to said property changes as results of user interactions on said graphic elements.

4. The method of claim 2 wherein said broadcast messages include a message that contains sufficient information to recreate a particular graphic element of said graphic elements from scratch.

5. The method of claim 4 wherein said message contains property values of said particular graphic element, said property values including at least one of color value, control value and positional value.

6. The method of claim 2 wherein said replaying includes processing said recording data using predefined time intervals to effectuate said property changes of said graphic elements for replay.

7. The method of claim 6 wherein said replaying further includes generating an update message that combines some of said property changes for a particular graphic element in response to a user input changing a current replay time to a different replay time.

8. The method of claim 1 wherein said replaying includes manipulating real operational graphic elements.

9. The method of claim 1 wherein said recording includes separately recording said graphical and functional information for each of said graphic elements as recording data that can be used to form unique data streams corresponding to different histories of property changes for said graphic elements.

10. The method of claim 9 wherein said replaying includes processing said recording data to run said unique data streams in parallel to replay said property changes of said graphic elements.

11. The method of claim 1 wherein said replaying comprises:
temporarily disabling a screen updating process;
resetting said computer environment to a recorded state at a particular time using said graphical and functional information of said graphic elements; and
enabling said screen updating process to display said recorded state of said computer environment.

12. A program storage device readable by a machine, tangibly embodying a program of instructions executable by said machine to perform a method for recording and replaying property changes of graphic elements in a computer environment, said method comprising:
recording graphical and functional information of said graphic elements as properties of said graphic elements are changed; and
replaying at least a portion of recorded changes pertaining to said properties of said graphic elements using said graphical and functional information.

13. The program storage device of claim 12 wherein said recording includes extracting said graphical and functional information of said graphic elements from broadcast messages and saving said graphical and functional information as recording data.

14. The program storage device of claim 13 wherein said graphical and functional information corresponds to said property changes as results of user interactions on said graphic elements.

15. The program storage device of claim 13 wherein said broadcast messages include a message that contains sufficient information to recreate a particular graphic element of said graphic elements from scratch.

16. The program storage device of claim 15 wherein said message contains property values of said particular graphic element, said property values including at least one of color value, control value and positional value.

17. The program storage device of claim 13 wherein said replaying includes processing said recording data using predefined time intervals to effectuate said property changes of said graphic elements for replay.

18. The program storage device of claim 17 wherein said replaying further includes generating an update message that combines some of said property changes for a particular graphic element in response to a user input changing a current replay time to a different replay time.

19. The program storage device of claim 12 wherein said replaying includes manipulating real operational graphic elements.

20. The program storage device of claim 12 wherein said recording includes separately recording said graphical and functional information for each of said graphic elements as recording data that can be used to form unique data streams corresponding to different histories of said property changes for said graphic elements.

21. The program storage device of claim 20 wherein said replaying includes processing said recording data to run said unique data streams in parallel to replay said property changes of said graphic elements.

22. The program storage device of claim 12 wherein said replaying comprises:
temporarily disabling a screen updating process;
resetting said computer environment to a recorded state at a particular time using said graphical and functional information of said graphic elements; and
enabling said screen updating process to display said recorded state of said computer environment.

23. A method for recording and replaying property changes of graphic elements in a computer environment comprising:
separately recording said property changes of each of said graphic elements with respect to time to form separate historical chains of property changes for said graphic elements; and
replaying said property changes of said graphic elements by manipulating said graphic elements using said separate historical chains of property changes, said graphic elements that are manipulated being real operational graphic elements.

24. The method of claim 23 wherein said separately recording includes extracting property change information of said graphic elements from broadcast messages and saving said property change information as recording data.

25. The method of claim 24 wherein said replaying includes processing said recording data using predefined time intervals to effectuate said property changes of said graphic elements for replay.

26. The method of claim 25 wherein said replaying further includes generating an update message that combines some of said property changes stored in said recording data in response to a user input changing a current replay time to a different replay time.

27. The method of claim 23 wherein said replaying includes processing unique data streams in parallel to replay said property changes of said graphic elements, said unique data streams corresponding to said separate historical chains of property changes.

28. The method of claim 23 wherein said replaying comprises:
temporarily disabling a screen updating process;
resetting said computer environment to a recorded state at a particular time using recorded property changes of said graphic elements; and
enabling said screen updating process to display said recorded state of said computer environment.
